(19) United States
(12) Patent Application Publication
(10) Pub. No.: US 2026/0332915 A1
(43) Pub. Date: Oct. 22, 2026

(54) IMAGING DEVICE, IMAGING SYSTEM, AND METHOD OF DRIVING IMAGING DEVICE

(71) Applicant: SONY SEMICONDUCTOR SOLUTIONS CORPORATION, KANAGAWA (JP)

(72) Inventors: TATSUYA ISHIKAWA, KANAGAWA (JP); KATSUHIKO HANZAWA, KANAGAWA (JP)

(21) Appl. No.: 19/109,702

(22) PCT Filed: Aug. 16, 2023
(86) PCT No.: PCT/JP2023/029594

§ 371 Date: Mar. 7, 2025

(30) Foreign Application Priority Data
Sep. 15, 2022 (JP) 2022-147343

(51) Int. Cl. H04N 25/78; H04N 25/65; H04N 25/709; H04N 25/771

(52) U.S. Cl. CPC H04N 25/78; H04N 25/65; H04N 25/709; H04N 25/771

(57) ABSTRACT

An imaging device according to one embodiment of the present disclosure includes a first photoelectric converter, a first floating diffusion, a first transfer transistor, a first readout circuit, and a voltage control section. The voltage control section is configured to execute control of supplying a first voltage to the first readout circuit in a case where a first signal is read while the first transfer transistor is in an off-state, and execute control of supplying a second voltage that is lower than the first voltage to the first readout circuit in a case where the first signal is read while the first transfer transistor is in an on-state.

### TECHNICAL FIELD

The present disclosure relates to an imaging device, an imaging system, and a method of driving an imaging device.

### BACKGROUND ART

An imaging device that switches an amount of change of a voltage with respect to electric charge, that is, a charge-voltage conversion efficiency has been proposed.

CITATION LIST

### Patent Literature

Patent Literature 1: Japanese Unexamined Patent Application Publication No. 2021-136634

### SUMMARY OF THE INVENTION

In the imaging device, there is a demand for suppression of increase in power consumption.

It is thus desirable to provide an imaging device that enables the power consumption to be reduced.

An imaging device according to one embodiment of the present disclosure includes: a first photoelectric converter that photoelectrically converts light; a first floating diffusion configured to store electric charge; a first transfer transistor configured to electrically couple the first photoelectric converter and the first floating diffusion to each other; a first readout circuit configured to output a first signal that is on a basis of the electric charge stored in the first floating diffusion; and a voltage control section configured to control supply of a voltage to the first readout circuit. The voltage control section is configured to execute control of supplying a first voltage to the first readout circuit in a case where the first signal is read while the first transfer transistor is in an off-state, and execute control of supplying a second voltage that is lower than the first voltage to the first readout circuit in a case where the first signal is read while the first transfer transistor is in an on-state.

An imaging system according to one embodiment of the present disclosure includes an imaging device and a voltage control section configured to control supply of a voltage to the imaging device. The imaging device includes: a photoelectric converter that photoelectrically converts light; a floating diffusion configured to store electric charge; a transfer transistor configured to electrically couple the photoelectric converter and the floating diffusion to each other; and a readout circuit configured to output a first signal that is on a basis of the electric charge stored in the floating diffusion. The voltage control section is configured to execute control of supplying a first voltage to the readout circuit in a case where the first signal is read while the transfer transistor is in an off-state, and execute control of supplying a second voltage that is lower than the first voltage to the readout circuit in a case where the first signal is read while the transfer transistor is in an on-state.

A method of driving an imaging device according to one embodiment of the present disclosure is a method of driving an imaging device including: a photoelectric converter; a floating diffusion; a transfer transistor configured to electrically couple the photoelectric converter and the floating diffusion to each other; a readout circuit configured to output a first signal that is on a basis of electric charge stored in the floating diffusion; and a voltage control section configured to control supply of a voltage to the readout circuit. The method of driving an imaging device includes: supplying a first voltage to the readout circuit in a case where the first signal is read while the transfer transistor is in an off-state; and supplying a second voltage that is lower than the first voltage to the readout circuit in a case where the first signal is read while the transfer transistor is in an on-state.

### BRIEF DESCRIPTION OF THE DRAWINGS

FIG. 1 is a block diagram illustrating an example of a schematic configuration of an imaging device according to an embodiment of the present disclosure.

FIG. 2 is a diagram illustrating an example of a pixel section of the imaging device according to the embodiment of the present disclosure.

FIG. 3 is a diagram illustrating a configuration example of a pixel of the imaging device according to the embodiment of the present disclosure.

FIG. 4 is a diagram illustrating a configuration example of a portion of the imaging device according to the embodiment of the present disclosure.

FIG. 5 is a timing chart illustrating an operation example of the imaging device according to the embodiment of the present disclosure.

FIG. 6A is a diagram illustrating a distribution of potentials in the imaging device according to the embodiment of the present disclosure.

FIG. 6B is a diagram illustrating a distribution of potentials in the imaging device according to the embodiment of the present disclosure.

FIG. 6C is a diagram illustrating a distribution of potentials in the imaging device according to the embodiment of the present disclosure.

FIG. 7 is a timing chart illustrating an operation example of the imaging device according to the embodiment of the present disclosure.

FIG. 8A is a diagram illustrating a distribution of potentials in the imaging device according to the embodiment of the present disclosure.

FIG. 8B is a diagram illustrating a distribution of potentials in the imaging device according to the embodiment of the present disclosure.

FIG. 8C is a diagram illustrating a distribution of potentials in the imaging device according to the embodiment of the present disclosure.

FIG. 9 is a flowchart illustrating an operation example of the imaging device according to the embodiment of the present disclosure.

FIG. 10A is a diagram illustrating a configuration example of a pixel of an imaging device according to Modification Example 1 of the present disclosure.

FIG. 10B is a diagram illustrating another configuration example of the pixel of the imaging device according to Modification Example 1 of the present disclosure.

FIG. 11A is a diagram illustrating a configuration example of a pixel of an imaging device according to Modification Example 2 of the present disclosure.

FIG. 11B is a diagram illustrating another configuration example of the pixel of the imaging device according to Modification Example 2 of the present disclosure.

FIG. 11C is a diagram illustrating another configuration example of the pixel of the imaging device according to Modification Example 2 of the present disclosure.

FIG. 12 is a diagram illustrating a configuration example of a pixel of an imaging device according to Modification Example 3 of the present disclosure.

FIG. 13 is a diagram illustrating another configuration example of the pixel of the imaging device according to Modification Example 3 of the present disclosure.

FIG. 14 is a diagram illustrating a configuration example of a pixel of an imaging device according to Modification Example 4 of the present disclosure.

FIG. 15 is a diagram illustrating a configuration example of a pixel of an imaging device according to Modification Example 5 of the present disclosure.

FIG. 16A is a diagram illustrating another configuration example of the pixel of the imaging device according to Modification Example 5 of the present disclosure.

FIG. 16B is a diagram illustrating another configuration example of the pixel of the imaging device according to Modification Example 5 of the present disclosure.

FIG. 17 is a diagram illustrating another configuration example of the pixel of the imaging device according to Modification Example 5 of the present disclosure.

FIG. 18A is a diagram illustrating a configuration example of a voltage control section of an imaging device according to Modification Example 6 of the present disclosure.

FIG. 18B is a diagram illustrating another configuration example of the voltage control section of the imaging device according to Modification Example 6 of the present disclosure.

FIG. 18C is a diagram illustrating another configuration example of the voltage control section of the imaging device according to Modification Example 6 of the present disclosure.

FIG. 18D is a diagram illustrating another configuration example of the voltage control section of the imaging device according to Modification Example 6 of the present disclosure.

FIG. 18E is a diagram illustrating another configuration example of the voltage control section of the imaging device according to Modification Example 6 of the present disclosure.

FIG. 19A is a diagram illustrating a layout example of an imaging device according to Modification Example 7 of the present disclosure.

FIG. 19B is a diagram illustrating another layout example of the imaging device according to Modification Example 7 of the present disclosure.

FIG. 19C is a diagram illustrating another layout example of the imaging device according to Modification Example 7 of the present disclosure.

FIG. 19D is a diagram illustrating another layout example of the imaging device according to Modification Example 7 of the present disclosure.

FIG. 20 is a block diagram illustrating a configuration example of an electronic apparatus including an imaging device.

FIG. 21 is a block diagram depicting an example of schematic configuration of a vehicle control system.

FIG. 22 is a diagram of assistance in explaining an example of installation positions of an outside-vehicle information detecting section and an imaging section.

FIG. 23 is a view depicting an example of a schematic configuration of an endoscopic surgery system.

FIG. 24 is a block diagram depicting an example of a functional configuration of a camera head and a camera control unit (CCU).

### MODES FOR CARRYING OUT THE INVENTION

Hereinafter, an embodiment of the present disclosure is described in detail with reference to the drawings. It is to be noted that description is given in the following order.
1. Embodiment
2. Modification Examples
3. Application Example
4. Usage Examples

### 1. Embodiment

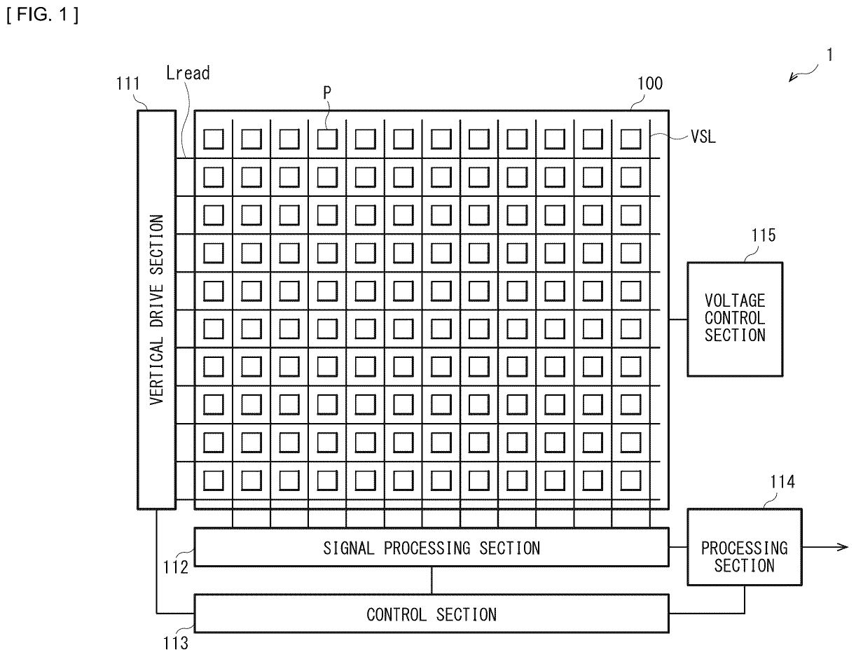

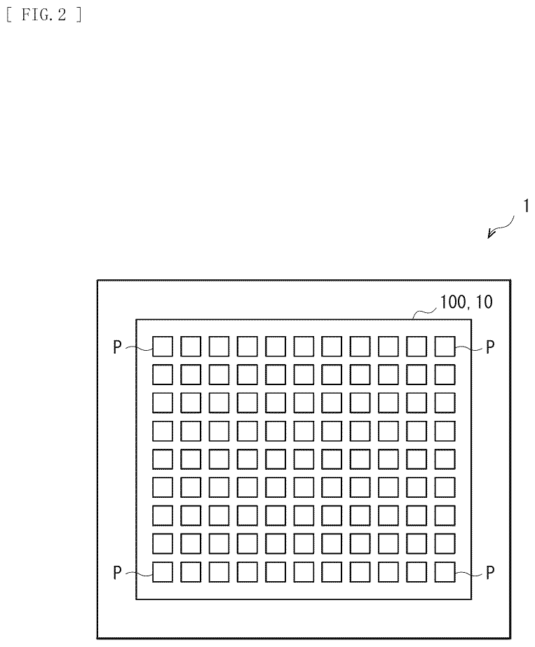

FIG. 1 is a block diagram illustrating an example of a schematic configuration of an imaging device according to an embodiment of the present disclosure. FIG. 2 is a diagram illustrating an example of a pixel section of the imaging device according to the embodiment. An imaging device 1 includes a plurality of pixels P each including a photoelectric converter, and is configured to photoelectrically convert entering light to generate a signal. The imaging device 1 may be applied to an image sensor, a ranging sensor, or the like.

The photoelectric converter of each pixel P of the imaging device 1 is, for example, a photodiode, and is configured to photoelectrically convert light. The imaging device 1 includes, as illustrated in FIG. 2, a region (a pixel section 100) including the plurality of pixels P two-dimensionally disposed in a matrix as an imaging area.

The imaging device 1 captures entering light (image light) from a subject via an optical system (not shown) including an optical lens. The imaging device 1 captures an image of the subject formed by the optical lens. The imaging device 1 photoelectrically converts the received light to generate a pixel signal. The imaging device 1 is, for example, a CMOS (Complementary Metal Oxide Semiconductor) image sensor. The imaging device 1 is applicable to an electronic apparatus such as a digital still camera, a video camera, or a mobile phone.

### Schematic Configuration of Imaging Device

The imaging device 1 includes, as in an example illustrated in FIG. 1, in a region around the pixel section 100, for example, a vertical drive section 111, a signal processing section 112, a control section 113, a processing section 114, a voltage control section 115, and the like. Further, the imaging device 1 includes, for example, a plurality of control lines Lread and a plurality of signal lines VSL.

In the example illustrated in FIG. 1, in the pixel section 100, each of the plurality of control lines Lread is wired for each pixel row including a plurality of pixels P arranged in the horizontal direction (row direction). The control line Lread is a signal line configured to transmit a signal for control of the pixel P. The control line Lread is configured to transmit a control signal for reading of a signal from the pixel P. It is possible to say that the control line Lread is a drive line that transmits a signal for drive of the pixel P.

Further, in the pixel section 100, the signal line VSL is wired for each pixel column including a plurality of pixels P arranged in the vertical direction (column direction). The signal line VSL is a signal line configured to transmit a signal from the pixel P. The signal line VSL is configured to transmit the signal output from the pixel P.

The vertical drive section 111 includes a shift register, an address decoder, or the like. The vertical drive section 111 is configured to drive each pixel P of the pixel section 100. The vertical drive section 111 generates a signal for drive of the pixel P, and outputs the signal to each pixel P of the pixel section 100 via the control line Lread. The vertical drive section 111 is controlled by the control section 113 to perform control of the pixel P of the pixel section 100.

The vertical drive section 111 generates, for example, a signal for control of the pixel P, such as a signal for control of a transfer transistor or a signal for control of a reset transistor, and supplies the signal to each pixel P by the control line Lread. The vertical drive section 111 is a pixel control section configured to control each pixel P, and may perform control of reading a pixel signal from each pixel P. It is to be noted that the vertical drive section 111 and the control section 113 may be regarded as the pixel control section together.

The signal processing section 112 is configured to execute signal processing on the signal of the pixel received as input. The signal processing section 112 includes, for example, a load circuit section, an AD (Analog Digital) conversion section, a horizontal selection switch, and the like. It is to be noted that the signal processing section 112 may include an amplification circuit section configured to amplify the signal read from the pixel P via the signal line VSL. The AD conversion section is, for example, a single-slope ADC (Analog to Digital Converter). It is to be noted that the AD conversion section may be other AD conversion circuits such as a successive approximation register (SAR) type, a delta-sigma type, a pipeline type, a cyclic type, a double integrating type, or a flash type.

The signal output from each pixel P selected and scanned by the vertical drive section 111 is input to the signal processing section 112 via the signal line VSL. The signal processing section 112 may perform, for example, signal processing such as AD conversion or CDS (Correlated Double Sampling) on the signal of the pixel P. The signal of each pixel P transmitted through each of the signal lines VSL is subjected to signal processing by the signal processing section 112, and is output to the processing section 114.

The processing section 114 is configured to execute signal processing on the input signal. The processing section 114 includes, for example, a circuit that performs various types of signal processing on the pixel signal. The processing section 114 may include a processor and a memory. The processing section 114 performs signal processing on the pixel signal input from the signal processing section 112, and outputs the pixel signal subjected to the processing. The processing section 114 may perform, for example, various types of signal processing such as noise reduction processing or gray-scale correction processing.

The voltage control section 115 is configured to control supply of a voltage to each section of the imaging device 1. The voltage control section 115 includes, for example, a circuit such as an amplifier circuit or a DC-DC converter. The voltage control section 115 is controlled by the control section 113, and is configured to supply a predetermined voltage (potential) to the pixel section 100, the vertical drive section 111, and the like. The voltage control section 115 is electrically coupled to a readout circuit of each pixel P to be described later, and may supply a volage and a current to the readout circuit of each pixel P.

The control section 113 is configured to control each section of the imaging device 1. The control section 113 may receive a clock, data regarding a command of an operation mode, or the like given from the outside, and may output data such internal information regarding the imaging device 1. The control section 113 includes a timing generator configured to generate various timing signals. The control section 113 performs drive control of the vertical drive section 111, the signal processing section 112, and the like on the basis of the various timing signals (such as a pulse signal or a clock signal) generated by the timing generator. It is to be noted that the control section 113 and the processing section 114 may be integrally configured.

It is to be noted that the vertical drive section 111, the signal processing section 112, the control section 113, the processing section 114, the voltage control section 115, and the like may be provided on one semiconductor substrate, or may be provided on a plurality of semiconductor substrates in a divided manner. The imaging device 1 may have a structure (multilayer structure) including a plurality of stacked substrates.

### Configuration of Pixel

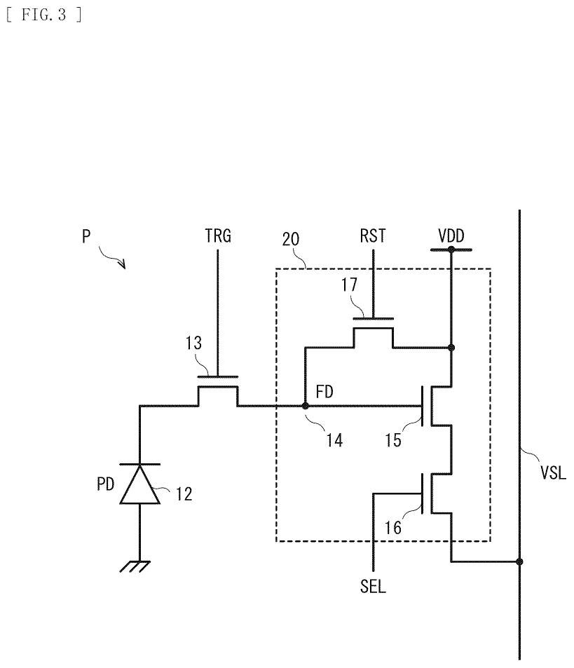

FIG. 3 is a diagram illustrating a configuration example of a pixel of the imaging device according to the embodiment. The pixel P includes a photoelectric converter 12, a transfer transistor 13, a FD (floating diffusion) 14, and a readout circuit 20. The readout circuit 20 is configured to output a signal that is on the basis of electric charge resulting from photoelectric conversion. The readout circuit 20 includes, as an example, an amplification transistor 15, a selection transistor 16, and a reset transistor 17. It is to be noted that the readout circuit 20 may include the FD 14.

The transfer transistor 13, the amplification transistor 15, the selection transistor 16, and the reset transistor 17 are each a MOS transistor (MOSFET) including a gate terminal, a source terminal, and a drain terminal. In the example illustrated in FIG. 3, the transfer transistor 13, the amplification transistor 15, the selection transistor 16, and the reset transistor 17 each include an NMOS transistor. It is to be noted that the transistor of the pixel P may include a PMOS transistor.

The photoelectric converter 12 is configured to generate electric charge by photoelectric conversion. In the example illustrated in FIG. 3, the photoelectric converter 12 is a photodiode (PD) buried and formed in a semiconductor substrate, and converts entering light into electric charge. The photoelectric converter 12 performs photoelectric conversion to generate electric charge corresponding to an amount of received light.

The transfer transistor 13 is configured to transfer the electric charge resulting from the photoelectric conversion at the photoelectric converter 12 to the FD 14. As illustrated in FIG. 3, the transfer transistor 13 is controlled by a signal TRG to electrically couple or decouple the photoelectric converter 12 and the FD 14. The transfer transistor 13 may transfer the stored electric charge resulting from the photoelectric conversion at the photoelectric converter 12 to the FD 14.

The FD 14 is a storing section, and is configured to store the transferred electric charge. The FD 14 may store the electric charge resulting from the photoelectric conversion at the photoelectric converter 12. It is possible to say that the FD 14 is also a holding section configured to hold the transferred electric charge. The FD 14 stores the transferred electric charge, and converts the electric charge into a voltage corresponding to the capacitance of the FD 14.

The amplification transistor 15 is configured to generate and output a signal that is on the basis of the electric charge stored in the FD 14. As illustrated in FIG. 3, a gate of the amplification transistor 15 is electrically coupled to the FD 14, and receives the voltage resulting from conversion at the FD 14 as input. A drain of the amplification transistor 15 is coupled to a power supply line to which a power supply voltage VDD is supplied, and a source of the amplification transistor 15 is coupled to the signal line VSL via the selection transistor 16. The amplification transistor 15 may generate a signal that is on the basis of the electric charge stored in the FD 14, that is, a signal that is on the basis of the voltage of the FD 14, and may output the signal to the signal line VSL.

The selection transistor 16 is configured to control the output of the signal of the pixel. The selection transistor 16 is controlled by a signal SEL, and is configured to output the signal from the amplification transistor 15 to the signal line VSL. The selection transistor 16 may control the timing to output the signal of the pixel. It is to be noted that the selection transistor 16 may be provided between the power supply line to which the power supply voltage VDD is supplied and the amplification transistor 15. Further, as required, the selection transistor 16 may be omitted.

The reset transistor 17 is configured to reset the voltage of the FD 14. In the example illustrated in FIG. 3, the reset transistor 17 is electrically coupled to the power supply line to which the power supply voltage VDD is supplied, and is configured to reset the electric charge of the pixel P. The reset transistor 17 is controlled by a signal RST, and may reset the electric charge stored in the FD 14 to reset the voltage of the FD 14. It is to be noted that the reset transistor 17 may discharge the electric charge stored in the photoelectric converter 12 via the transfer transistor 13.

The vertical drive section 111 (see FIG. 1) supplies control signals to the gates of the transfer transistor 13, the selection transistor 16, the reset transistor 17, and the like of each pixel P via the above-described control line Lread to bring the transistors to an on-state (conductive state) or an off-state (non-conductive state). The plurality of control lines Lread of the imaging device 1 includes wiring that transmits the signal TRG for control of the transfer transistor 13, wiring that transmits the signal SEL for control of the selection transistor 16, wiring that transmits the signal RST for control of the reset transistor 17, and the like.

The transfer transistor 13, the selection transistor 16, the reset transistor 17, and the like are controlled to be turned on or off by the vertical drive section 111. The vertical drive section 111 controls the signal TRG, the signal SEL, the signal RST, and the like that are input to each pixel P to cause the signal from the amplification transistor 15 of each pixel P to be output to the signal line VSL.

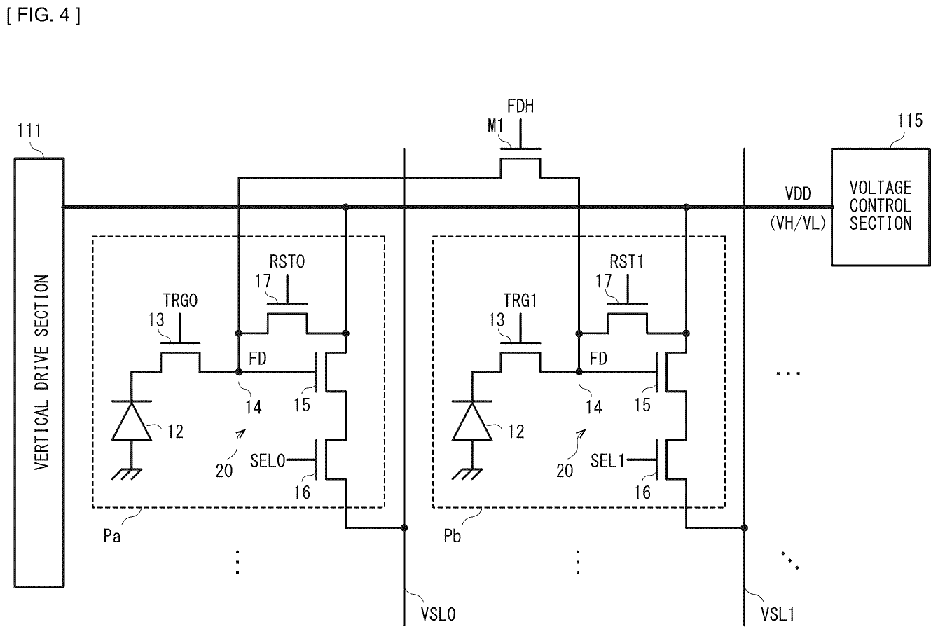

FIG. 4 is a diagram illustrating a configuration example of a portion of the imaging device according to the embodiment. FIG. 4 illustrates some pixels (a pixel Pa and a pixel Pb) of the pixel section 100, the vertical drive section 111, and the voltage control section 115. The imaging device 1 includes, as illustrated in FIG. 4, a transistor M1. The transistor M1 is configured to electrically couple or decouple the FDs 14 of the plurality of pixels P to or from each other. The transistor M1 is configured to electrically couple, for example, the FDs 14 of two pixels P adjacent in the row direction (or the column direction) to each other. The transistor M1 is, for example, an NMOS transistor.

In the imaging device 1, for example, the transistor M1 is provided for every two pixels P adjacent in the row direction. The transistor M1 illustrated in FIG. 4 is configured to electrically couple the FD 14 of the pixel Pa and the FD 14 of the pixel Pb to each other. The transistor M1 is controlled by a signal FDH input from the vertical drive section 111, and electrically couples or decouples the FD 14 of the pixel Pa and the FD 14 of the pixel Pb to or from each other.

In a case where the transistor M1 is in an off-state, the FD 14 of the pixel Pa and the FD 14 of the pixel Pb are electrically decoupled from each other, and the electric charge transferred from the photoelectric converter 12 of the pixel Pa is stored in the FD 14 of the pixel Pa. In a case where the transistor M1 is in an on-state, the FD 14 of the pixel Pa and the FD 14 of the pixel Pb are electrically coupled to each other, and the electric charge transferred from the photoelectric converter 12 of the pixel Pa is stored in the FD 14 of the pixel Pa and the FD 14 of the pixel Pb.

Upon turning-on of the transistor M1, the capacitance added to the FD 14 of the pixel Pa is increased, which makes is possible to change the conversion efficiency (gain) at the time of converting the electric charge into the voltage. It is possible to say that the transistor M1 is also a switching transistor that switches the capacitance coupled to the gate of the amplification transistor 15 to change the conversion efficiency. It is possible to say that the pixel P is also a pixel configured to switch the conversion efficiency.

The imaging device 1 according to the present embodiment includes a plurality of operation modes. The imaging device 1 includes, for example, as the operation modes, a first mode and a second mode. The first mode is a normal mode, and the second mode is a low power mode. The control section 113 (see FIG. 1) controls the vertical drive section 111, the voltage control section 115, and the like depending on the operation mode set in the imaging device 1. The operation mode of the imaging device 1 may be automatically set by the imaging device 1, or may be set by a user.

In a case where the imaging device 1 is set to the first mode (normal mode), for example, the control section 113 controls the vertical drive section 111 to bring each transistor M1 provided in the pixel section 100 to the off-state. Upon tuning-off of each transistor M1 of the pixel section 100, no capacitance of the FD 14 of another pixel P is added to the FD 14 of the pixel P, and the pixel P is brought to a state of having a relatively high conversion efficiency.

In the case of the first mode, the vertical drive section 111 may perform processing of transferring the electric charge resulting from the photoelectric conversion at the photoelectric converter 12 while the transfer transistor 13 is in the off-state to the FD 14 by bringing the transfer transistor 13 to the on-state, and reading the signal from each pixel P. As described above, in the case of the first mode, it is possible to increase the sensitivity of the imaging device 1, which makes it possible to obtain a high-resolution image. It is possible to say that the first mode is a high-resolution imaging mode.

In the case of the second mode (low power mode), the vertical drive section 111 keeps the transfer transistor 13 in the on-state (Always ON state) during an exposure period (electric charge storage period), and brings the photoelectric converter 12 and the FD 14 to an electrically coupled state. The capacitance of the FD 14 or the like of another pixel P is added to the FD 14 of the pixel P, and the pixel P is brought to a state of having a relatively low conversion efficiency. In the case of the second mode, the vertical drive section 111 may perform processing of causing the photoelectric converter 12 and the FD 14 to store the electric charge resulting from the photoelectric conversion during the exposure period, and reading the pixel signal from each pixel P.

In the case of the second mode, as described above, the Always ON operation of the transfer transistor 13 is performed. Thus, the photoelectric converter 12 and the FD 14 that are electrically coupled to each other store the electric charge resulting from the photoelectric conversion, and the pixel signal that is on the basis of the electric charge resulting from the photoelectric conversion is read. In the second mode, the vertical drive section 111 may read the pixel signal without performing complete electric charge transfer from the photoelectric converter 12 to the FD 14. This makes it possible to reduce the power supply voltage VDD as compared with a case where the complete electric charge transfer is performed. This allows the power consumption of the imaging device 1 to be reduced.

In the imaging device 1 according to the present embodiment, in the case of the second mode, as described above, the capacitance added to the FD 14 is increased. This makes it possible to reduce a magnitude of a reset noise (kT/C noise), and thus makes it possible to suppress the increase of the noise even in a case where the value of the drain voltage of the amplification transistor 15 (power supply voltage VDD in FIG. 3) is decreased. Reducing the reset noise allows the noise of the pixel signal to be reduced even in the case of the second mode in which no CDS (correlated double sampling) processing is allowed. It is possible to reduce the power consumption while the increase of the noise is suppressed.

Further, the increase of the capacitance added to the FD 14 of the pixel P allows a range of the voltage input to the amplification transistor 15 to become narrower. This makes it possible to read the pixel signal even in a case where the operation range of the amplification transistor 15 is narrowed due to the decrease of the power supply voltage VDD.

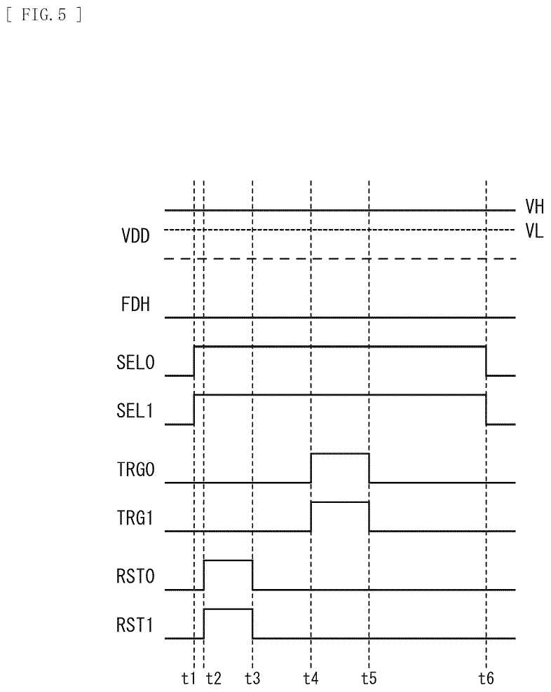

Next, with reference to, for example, FIG. 4 to FIG. 8, the imaging device 1 according to the present embodiment is further described. FIG. 5 is a timing chart illustrating an operation example of the imaging device in the case of the first mode. The timing chart of FIG. 5 illustrates, with use of the horizontal axis as time, the control signals (drive signals), the power supply voltage, and the like supplied to the pixel P of the imaging device 1.

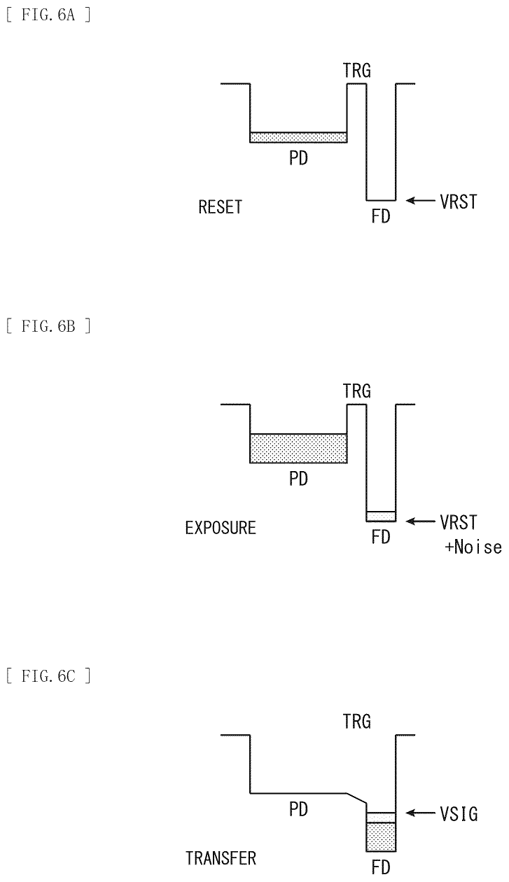

In FIG. 5, a transistor that has received a high-level control signal as input is brought to an on-state (conductive state), and a transistor that has received a low-level control signal as input is brought to an off-state (non-conductive state). FIG. 6A to FIG. 6C are each a diagram illustrating a distribution of potentials in the pixel of the imaging device in the case of the first mode.

The voltage value of the power supply voltage VDD is switchable between, for example, a first voltage (voltage at a high level (VH) in FIG. 5) and a second voltage (voltage at a low level (VL) in FIG. 5) that is lower than the first voltage. In the case of the first mode, the voltage control section 115 supplies a high-level (VH) power supply voltage VDD to the readout circuit 20 (the amplification transistor 15, the reset transistor 17, and the like) of each pixel P. Further, in the case of the first mode, the signal FDH is at a low level, and the transistor M1 is in the off-state.

At a time t1, a signal SEL0 and a signal SEL1 are each brought to a high level. When the signal SELO and the signal SEL1 are each brought to a high level, the selection transistor 16 of the pixel Pa and the selection transistor 16 of the pixel Pb illustrated in FIG. 4 are each brought to the on-state.

At a time t2, a signal RST0 and a signal RST1 are each brought to a high level. When the signal RST0 and the signal RST1 are each brought to a high level, the reset transistor 17 of the pixel Pa and the reset transistor 17 of the pixel Pb are each brought to the on-state. The FD 14 of the pixel Pa and the FD 14 of the pixel Pb are electrically coupled to the power supply line to which the high-level (VH) power supply voltage VDD is supplied. This causes, in the pixel Pa, as illustrated in FIG. 6A, the electric charge in the FD 14 to be discharged, and the voltage of the FD 14 is reset to a reset voltage VRST.

At a time t3, the signal RST0 and the signal RST1 are each brought to a low level. When the signal RST0 and the signal RST1 are each brought to a low level, the reset transistor 17 of the pixel Pa and the reset transistor 17 of the pixel Pb are each brought to the off-state. The photoelectric converter 12 of each of the pixel Pa and the pixel Pb photoelectrically converts the entering light, and stores the generated electric charge. In the pixel Pa, as illustrated in FIG. 6B, the electric charge is stored through the photoelectric conversion, and the potential (voltage) of the photoelectric converter 12 is decreased.

At a time t4, a signal TRG0 and a signal TRG1 are each brought to a high level. When the signal TRG0 and the signal TRG1 are each brought a high level, the transfer transistor 13 of the pixel Pa and the transfer transistor 13 of the pixel Pb are each brought to the on-state. In the pixel Pa, as illustrated in FIG. 6C, the stored electric charge resulting from the photoelectric conversion at the photoelectric converter 12 is transferred to the FD 14.

The selection transistor 16 of the pixel Pa is in the on-state, and hence a pixel signal corresponding to a voltage VSIG of the FD 14 of the pixel Pa is output to a signal line VSL0 coupled to the pixel Pa by the amplification transistor 15. Further, the selection transistor 16 of the pixel Pb is in the on-state, and hence a pixel signal corresponding to the voltage of the FD 14 of the pixel Pb is output to a signal line VSL1 coupled to the pixel Pb by the amplification transistor 15.

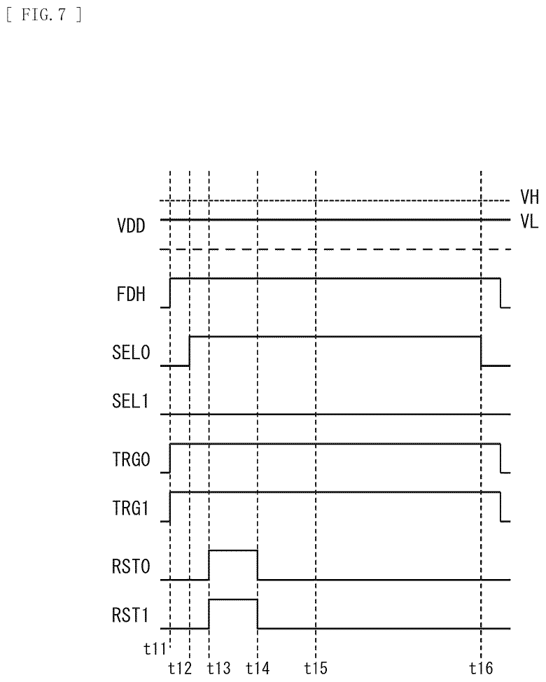

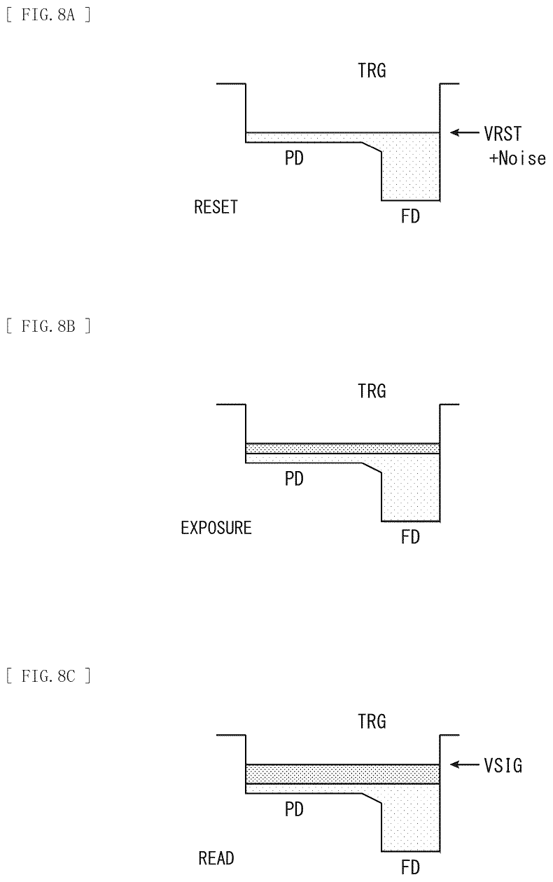

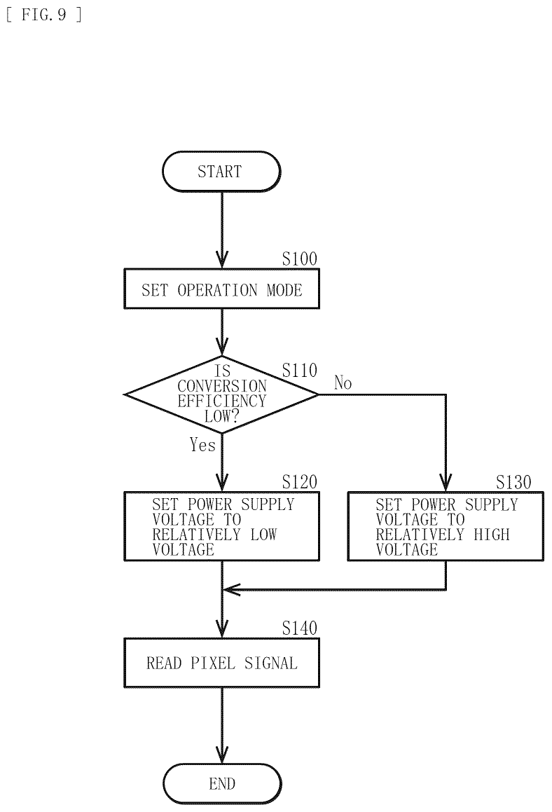

FIG. 7 is a timing chart illustrating an operation example of the imaging device in the case of the second mode. Further, FIG. 8A to FIG. 8C are each a diagram illustrating a distribution of potentials in the pixel of the imaging device in the case of the second mode. In the case of the second mode, the voltage control section 115 supplies the low-level (VL) power supply voltage VDD to the readout circuit 20 or the like of each pixel P.

At a time t11, the signal FDH is brought to a high level. When the signal FDH is brought to a high level, the transistor M1 is brought to the on-state, and the FD 14 of the pixel Pa and the FD 14 of the pixel Pb are electrically coupled to each other. This brings the FD 14 of the pixel Pa to a state of having the capacitance of the FD 14 of the pixel Pb added thereto.

Further, at the time t11, the signal TRGO and the signal TRG1 are each brought to a high level. When the signal TRGO and the signal TRG1 are each brought to a high level, the transfer transistor 13 of the pixel Pa and the transfer transistor 13 of the pixel Pb are each brought to the on-state. In each of the pixel Pa and the pixel Pb, the photoelectric converter 12 and the FD 14 are electrically coupled to each other. This brings the FD 14 of the pixel Pa to a state of having the capacitance of the photoelectric converter 12, the capacitance of the FD 14 of the pixel Pb, and the like added thereto. At a time t12, the signal SEL0 is brought to a high level, and thus the selection transistor 16 of the pixel Pa is brought to the on-state.

At a time t13, the signal RST0 and the signal RST1 are each brought to a high level. When the signal RST0 and the signal RST1 are each brought to a high level, the reset transistor 17 of the pixel Pa and the reset transistor 17 of the pixel Pb are each brought to the on-state. The FD 14 of the pixel Pa and the FD 14 of the pixel Pb are electrically coupled to the power supply line to which the low-level (VL) power supply voltage VDD is supplied. This causes, in the pixel Pa, as illustrated in FIG. 8A, the voltage of the FD 14 to be reset to the reset voltage VRST.

At a time t14, the signal RST0 and the signal RST1 are each brought to a low level, and hence the reset transistor 17 of the pixel Pa and the reset transistor 17 of the pixel Pb are each brought to the off-state. The photoelectric converter 12 of each of the pixel Pa and the pixel Pb photoelectrically converts the entering light, and stores the generated electric charge.

The electric charge resulting from the photoelectric conversion at the pixel Pa is stored and added in the photoelectric converter 12 and the FD 14 of the pixel Pa, and the electric charge resulting from the photoelectric conversion at the pixel Pb is stored and added in the photoelectric converter 12 and the FD 14 of the pixel Pb. In the pixel Pa, as illustrated in FIG. 8B, the electric charge resulting from the photoelectric conversion is stored, and the potentials (voltages) of the photoelectric converter 12 and the FD 14 are reduced.

At a time t15 after an elapse of the exposure period, because the selection transistor 16 of the pixel Pa is in the on-state, as illustrated in FIG. 8C, a pixel signal corresponding to the voltage VSIG of the FD 14 of the pixel Pa is output to the signal line VSL0 coupled to the pixel Pa. It is possible to read, to the signal line VSL0, a pixel signal that is on the basis of the electric charge obtained by adding the electric charges resulting from the photoelectric conversion at the pixel Pa and the pixel Pb.

FIG. 9 is a flowchart illustrating an operation example of the imaging device according to the embodiment. With reference to the flowchart of FIG. 9, the operation example of the imaging device is described. In Step S100 illustrated in FIG. 9, for example, the user operates the imaging device 1 to set the operation mode of the imaging device 1.

The control section 113 of the imaging device 1 controls the vertical drive section 111 to change the conversion efficiency of the pixel P depending on the set operation mode. For example, in a case where the control section 113 instructs the vertical drive section 111 to perform the second mode, as described above, control is performed to add the capacitance to the FD 14.

In Step S110, the control section 113 determines whether or not a low conversion efficiency is set for the pixel P. In a case where, for example, the transistor M1 is in the on-state and the capacitance is added to the FD 14, the control section 113 determines that the pixel P has a low conversion efficiency, and the processing proceeds to Step S120. In a case where the transistor M1 is in the off-state and no capacitance is added to the FD 14, the control section 113 determines that the pixel P has a high conversion efficiency, and the processing proceeds to Step S130.

In Step S120, the control section 113 controls the voltage control section 115 to set the power supply voltage VDD to be supplied to the readout circuit 20 of the pixel P to a relatively low voltage (VL). In Step S130, the control section 113 controls the voltage control section 115 to set the power supply voltage VDD to be supplied to the readout circuit 20 of the pixel P to a relatively high voltage (VH).

In Step S140, the control section 113 controls the vertical drive section 111 or the like to read the pixel signal from each pixel P of the pixel section 100. After the pixel signal is read from each pixel P serving as a reading target, the imaging device 1 ends the processing illustrated in the flowchart of FIG. 9.

### Actions and Effects

The imaging device (imaging device 1) according to the present embodiment includes: a first photoelectric converter (photoelectric converter 12) that photoelectrically converts light; a first floating diffusion (FD 14) configured to store electric charge; a first transfer transistor (transfer transistor 13) configured to electrically couple the first photoelectric converter and the first floating diffusion to each other; a first readout circuit (readout circuit 20) configured to output a first signal that is on a basis of the electric charge stored in the first floating diffusion; and a voltage control section (voltage control section 115) configured to control supply of a voltage to the first readout circuit. The voltage control section is configured to execute control of supplying a first voltage (high-level (VH) power supply voltage) to the first readout circuit in a case where the first signal is read while the first transfer transistor is in an off-state (in the case of a first mode). The voltage control section is further configured to execute control of supplying a second voltage (low-level (VL) power supply voltage) that is lower than the first voltage to the first readout circuit in a case where the first signal is read while the first transfer transistor is in an on-state (in the case of a second mode).

In the imaging device 1 according to the present embodiment, the voltage control section 115 performs the control of supplying the high-level (VH) power supply voltage to the readout circuit 20 in the case of the first mode, and performs the control of supplying the low-level (VL) power supply voltage to the readout circuit 20 in the case of the second mode. This makes it possible to suppress the increase in power consumption. It is thus possible to achieve an imaging device that enables the power consumption to be reduced.

Next, modification examples of the present disclosure are described. In the following, components similar to those of the above-described embodiment are denoted by the same reference symbols, and description thereof is omitted as appropriate.

### 2. Modification Examples

### 2-1. Modification Example 1

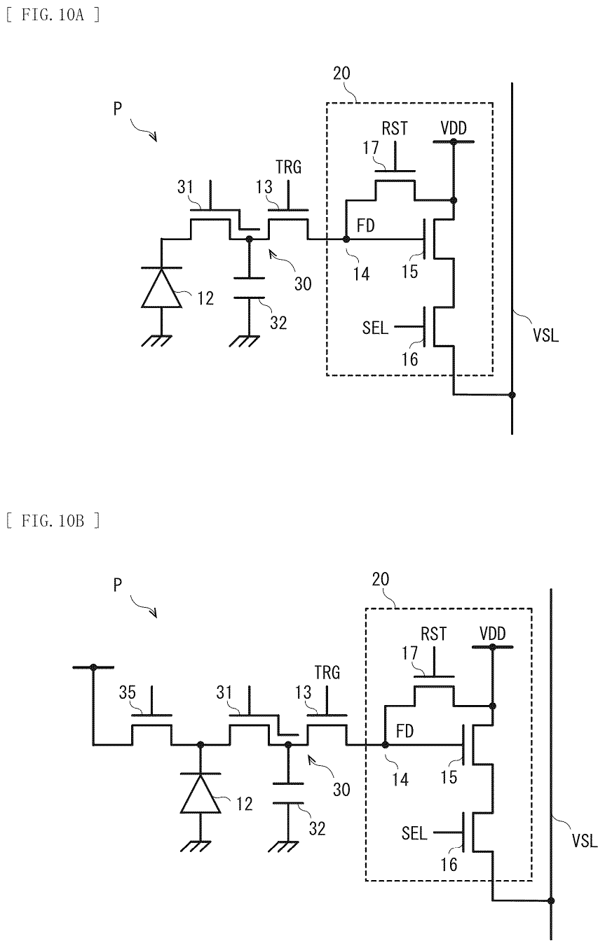

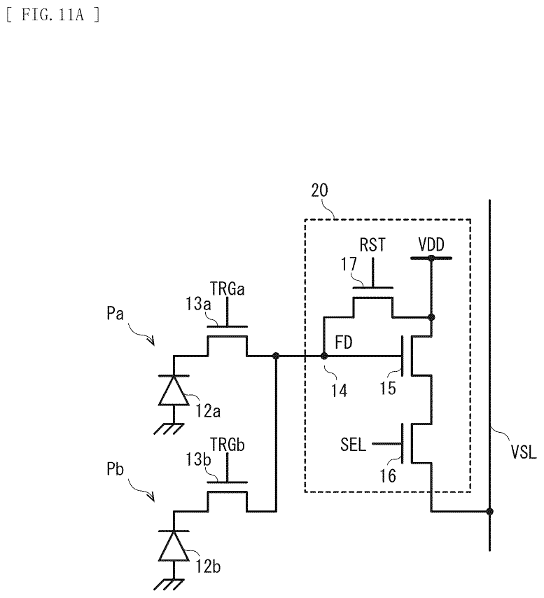

FIG. 10A is a diagram illustrating a configuration example of a pixel of an imaging device according to Modification Example 1 of the present disclosure. The pixel P of the imaging device 1 may include, as illustrated in FIG. 10A, a memory section 30. The memory section 30 is configured to hold the electric charge resulting from the photoelectric conversion at the photoelectric converter 12. For example, the memory section 30 is buried and formed between the photoelectric converter 12 and the FD 14 in the semiconductor substrate. In the example illustrated in FIG. 10A, the memory section 30 includes a transistor 31 and a capacitor element 32. The capacitor element 32 is configured to store electric charge. The transistor 31 is configured to transfer the electric charge resulting from the photoelectric conversion at the photoelectric converter 12 to the capacitor element 32.

FIG. 10B is a diagram illustrating another configuration example of the pixel of the imaging device according to Modification Example 1 of the present disclosure. The pixel P of the imaging device 1 may include, as illustrated in FIG. 10B, a transistor 35. The transistor 35 is configured to reset the voltage of the photoelectric converter 12. In the example illustrated in FIG. 10B, the transistor 35 is electrically coupled to the power supply line to which the power supply voltage is supplied, and is configured to reset the electric charge of the photoelectric converter 12. The transistor 35 may reset the electric charge stored in the photoelectric converter 12 to reset the voltage of the photoelectric converter 12. It is to be noted that the readout circuit 20 may include the transistor 35.

### 2-2. Modification Example 2

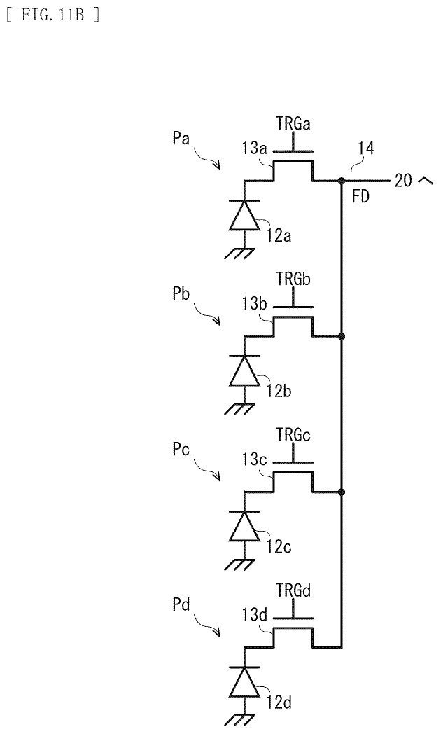

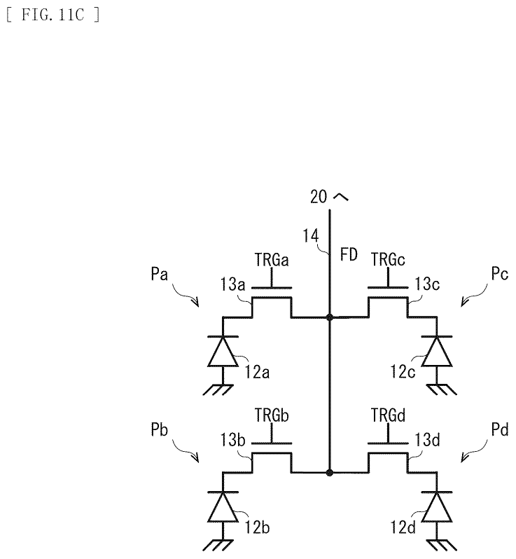

FIG. 11A is a diagram illustrating a configuration example of a pixel of an imaging device according to Modification Example 2. As illustrated in FIG. 11A, the imaging device 1 may have a configuration in which a plurality of pixels P shares one FD 14. In the example illustrated in FIG. 11A, the pixel Pa and the pixel Pb share one readout circuit 20.

In the example illustrated in FIG. 11A, a transistor 13a is controlled by a signal TRGa supplied from the vertical drive section 111, and is configured to electrically couple a photoelectric converter 12a and the FD 14 to each other. Further, a transistor 13b is controlled by a signal TRGb supplied from the vertical drive section 111, and is configured to electrically couple a photoelectric converter 12b and the FD 14 to each other.

Upen turning-on of the transistor 13a and the transistor 13b, the capacitance added to the FD 14 is increased, which makes it possible to change the conversion efficiency. This makes is possible to set the power supply voltage to be supplied to the readout circuit 20 to a low voltage in the case of the second mode, and thus to reduce the power consumption while suppressing the reset noise. Even in the case of this modification example, it is possible to obtain effects similar to those of the above-described embodiment.

It is to be noted that, as illustrated in FIG. 11B or FIG. 11C, the imaging device 1 may be configured to allow four pixels P to be electrically coupled to each other via transistors. The imaging device 1 may have a configuration in which a plurality of pixels P of any number (for example, four, eight, or the like) arranged in the row direction (horizontal direction) or the column direction (vertical direction) shares the FD 14 or the like. Further, a plurality of pixels P arranged in an oblique direction may share the FD 14 or the like.

### 2-3. Modification Example 3

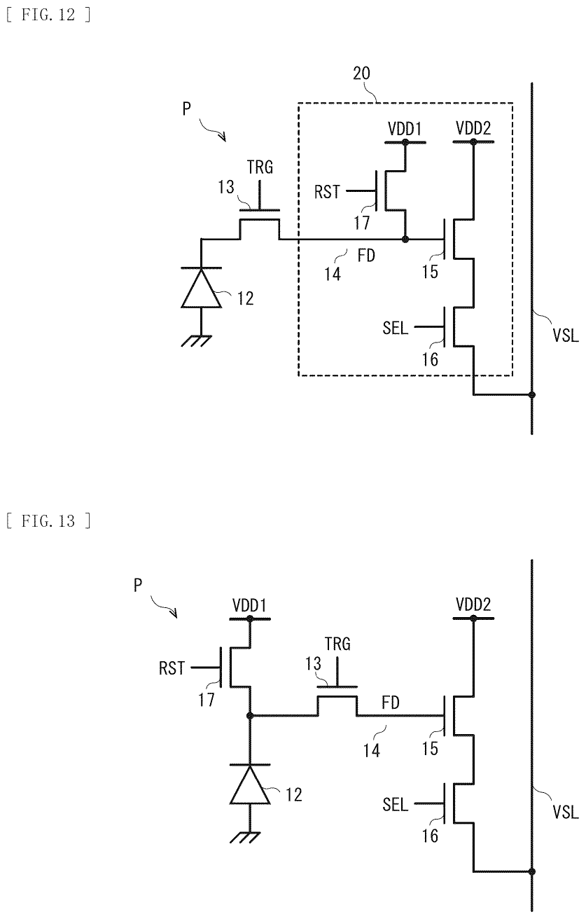

FIG. 12 and FIG. 13 are diagrams illustrating configuration examples of a pixel of an imaging device according to Modification Example 3. In the examples illustrated in FIG. 12 and FIG. 13, the reset transistor 17 is electrically coupled to a power supply line to which a power supply voltage VDD1 is supplied, and the amplification transistor 15 is electrically coupled to a power supply line to which a power supply voltage VDD2 is supplied.

The voltage control section 115 may set, in the case of the second mode, the power supply voltage VDD2 to be supplied to the amplification transistor 15 to a low voltage, and set the power supply voltage VDD1 to be supplied to the reset transistor 17 to a low voltage. The voltage control section 115 may individually set the power supply voltage VDD1 and the power supply voltage VDD2 to low voltages. Further, in the case of the second mode, the voltage control section 115 may reduce the power supply voltage to be supplied to the vertical drive section 111 to decrease the voltage level of the control signal supplied from the vertical drive section 111 to the pixel P.

### 2-4. Modification Example 4

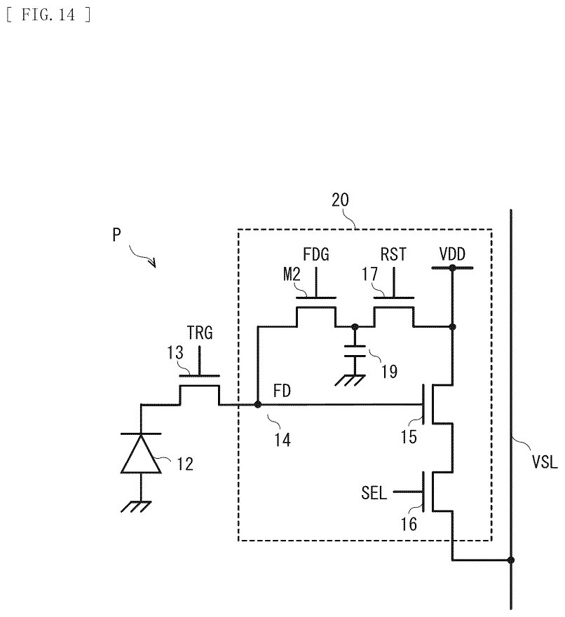

FIG. 14 is a diagram illustrating a configuration example of a pixel of an imaging device according to Modification Example 4. As illustrated in FIG. 14, the pixel P of the imaging device 1 may include a transistor M2 and a capacitor element 19. The capacitor element 19 is configured to store electric charge. The capacitor element 19 is coupled to the transistor M2 and the reset transistor 17. The transistor M2 is configured to electrically couple the FD 14 and the capacitor element 19 to each other.

In a case where the transistor M2 is in the off-state, the FD 14 and the capacitor element 19 are electrically decoupled from each other, and the electric charge transferred from the photoelectric converter 12 is stored in the FD 14. In a case where the transistor M2 is in the on-state, the FD 14 and the capacitor element 19 are electrically coupled to each other, and the electric charge transferred from the photoelectric converter 12 is stored in the FD 14 and the capacitor element 19.

Upon turning-on of the transistor M2, the capacitance added to the FD 14 is increased, which makes it possible to change the conversion efficiency. It is possible to say that the transistor M2 is also a switching transistor that switches the capacitance coupled to the gate of the amplification transistor 15 to change the conversion efficiency.

The vertical drive section 111 brings, in the case of the second mode, the transistor M2 to the on-state to bring the FD 14 and the capacitor element 19 to an electrically coupled state. The capacitance of the capacitor element 19 is added to the FD 14 of the pixel P, and thus the pixel P is brought to a state of having a relatively low conversion efficiency. This makes it possible to set the power supply voltage to be supplied to the readout circuit 20 to a low voltage, and thus to reduce the power consumption while suppressing the reset noise. Even in the case of this modification example, it is possible to obtain effects similar to those of the above-described embodiment.

### 2-5. Modification Example 5

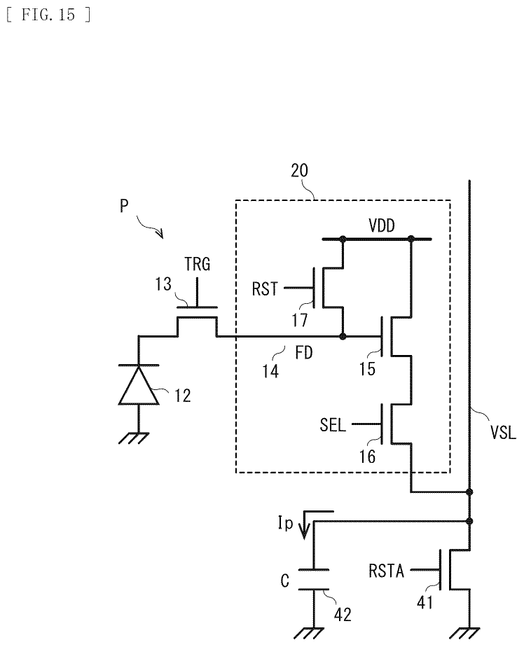

The configuration examples of the pixel P have been described in the above-described embodiment and modification examples, but the configuration of the pixel P is not limited to the above-described examples. FIG. 15 is a diagram illustrating a configuration example of a pixel of an imaging device according to Modification Example 5. As illustrated in FIG. 15, the imaging device 1 may include a transistor 41 and a capacitor element 42 that are provided to the signal line VSL. After the transistor 41 resets the voltage of the signal line VSL to a GND potential (ground potential), the selection transistor 16 is brought to the on-state. This makes it possible to supply a current Ip from the amplification transistor 15 to the capacitor element 42 to thus read the pixel signal to the signal line VSL.

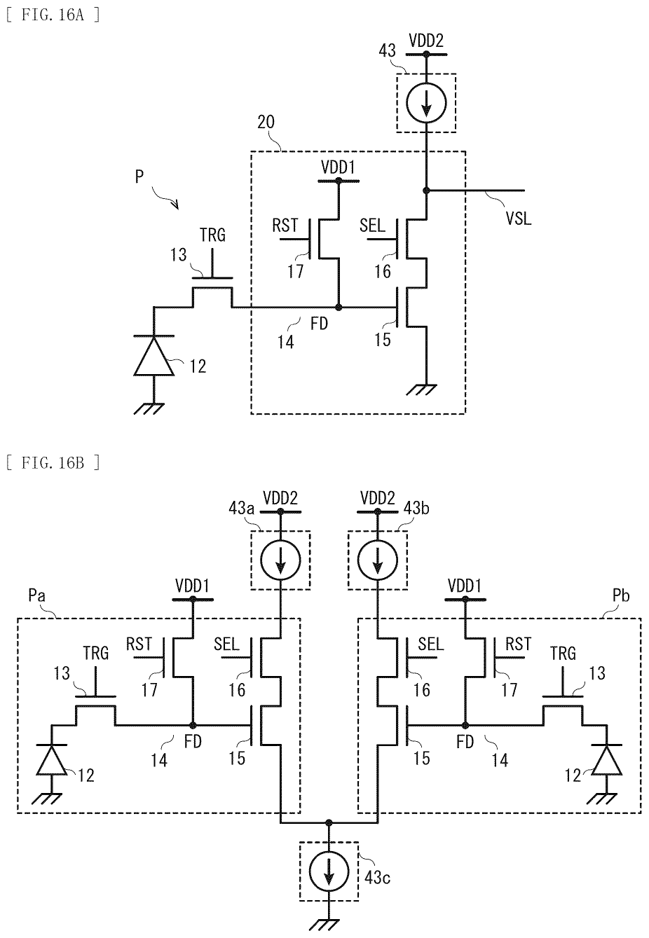

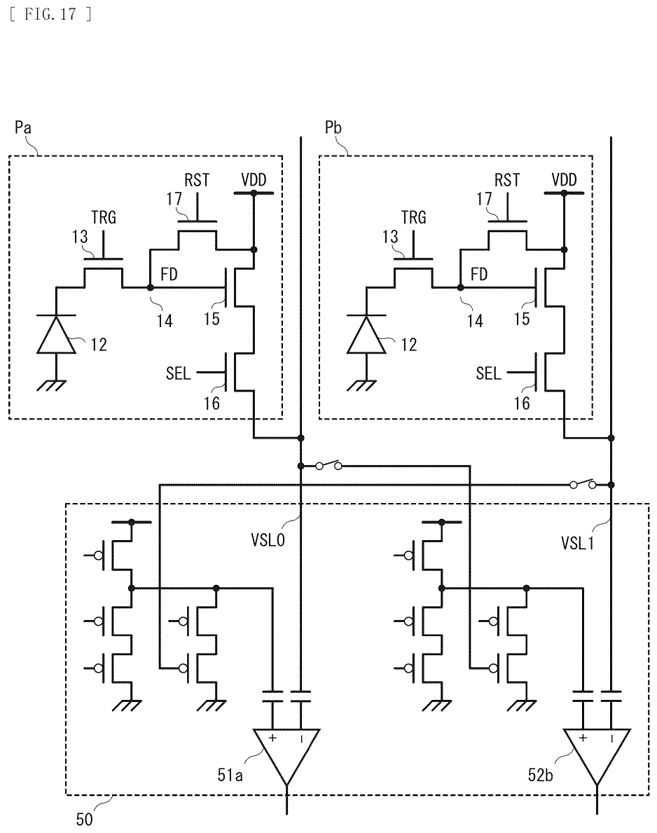

It is to be noted that, as illustrated in FIG. 16A, the imaging device 1 may include a common-source circuit configured with use of a current source 43 and the amplification transistor 15 of the pixel P. Further, as illustrated in FIG. 16B, the pixel P may be a pixel of a differential amplifier configuration. As illustrated in FIG. 17, the imaging device 1 may include a comparison circuit 50 configured to compare signals of the respective pixels P. In the example illustrated in FIG. 17, the comparison circuit 50 causes comparator circuits 51a and 51b to compare the pixel signals of the pixel Pa and the pixel Pb to extract an edge of a subject.

### 2-6. Modification Example 6

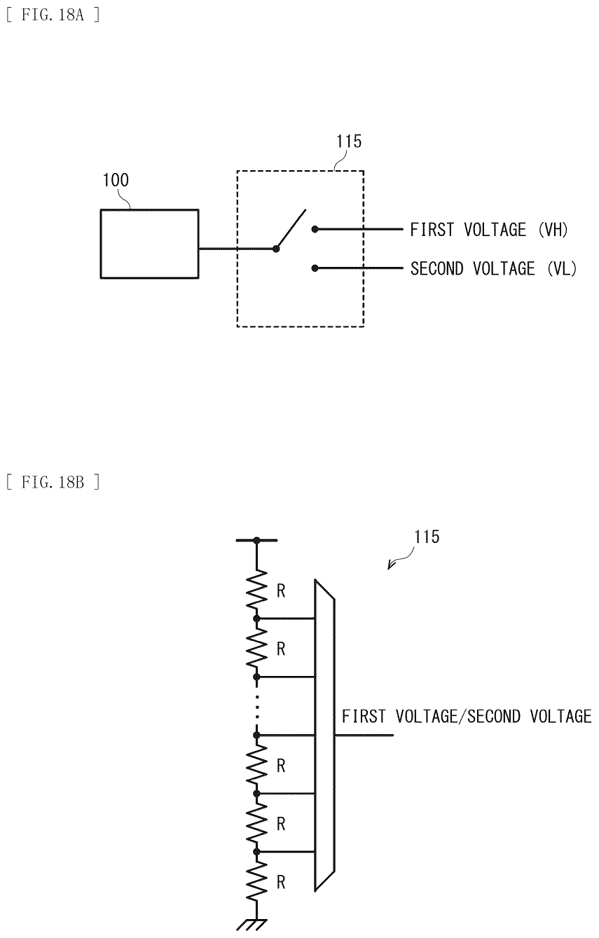

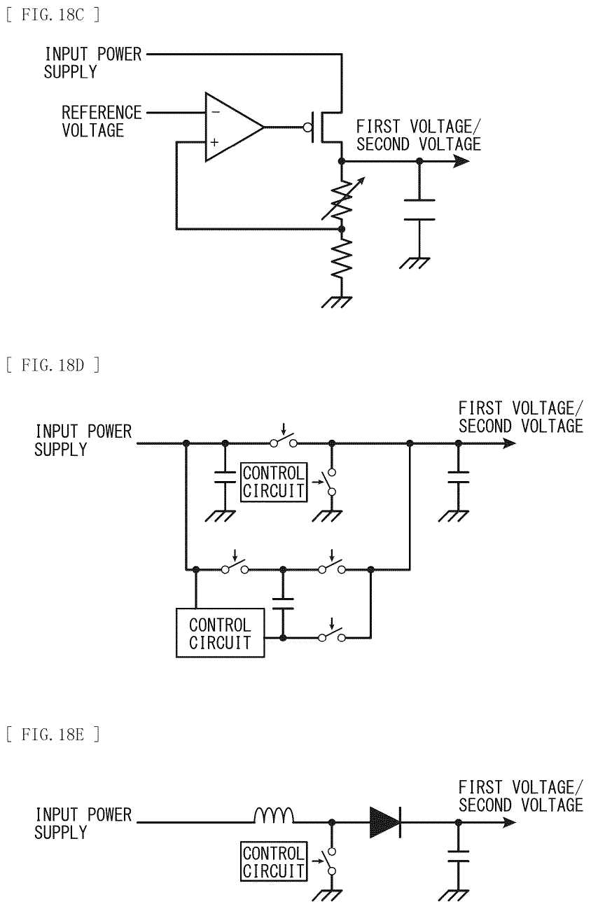

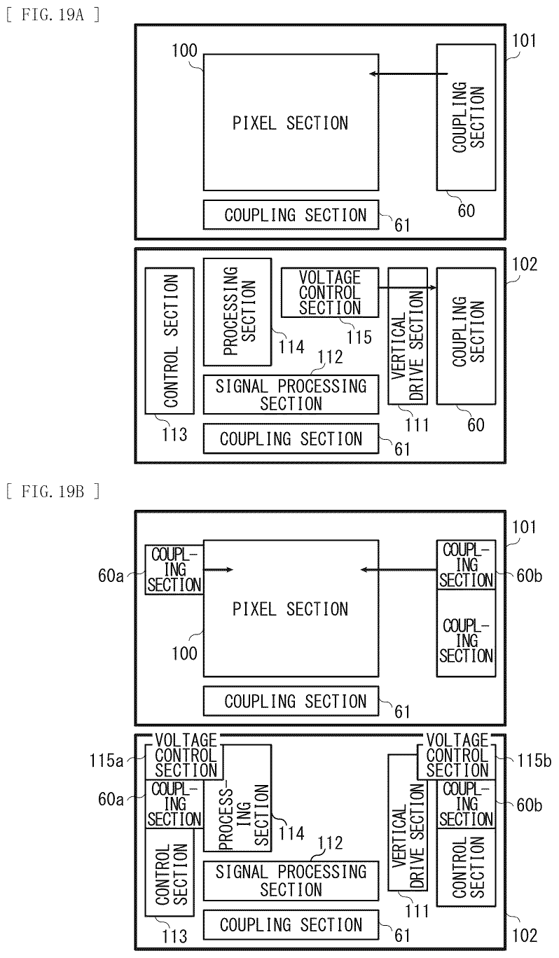

FIG. 18A to FIG. 18E are diagrams illustrating configuration examples of a voltage control section of an imaging device according to Modification Example 6. The voltage control section 115 may include, for example, as schematically illustrated in FIG. 18A, a circuit (a switch circuit, a selector circuit, or the like) configured select and output a first voltage (for example, a high-level (VH) power supply voltage) or a second voltage (for example, a low-level (VL) power supply voltage) input from the outside. Further, for example, as illustrated in FIG. 18B, the voltage control section 115 may include a resistor divider circuit configured with use of a plurality of resistor elements and a selector circuit.

The voltage control section 115 may include, as illustrated in FIG. 18C, an amplifier circuit. In the example illustrated in FIG. 18C, the voltage control section 115 is configured with use of an LDO (Low Drop Out) circuit, and may control a resistance value of a variable resistor to adjust an output voltage and output the first voltage or the second voltage. Further, for example, as illustrated in FIG. 18D or FIG. 18E, the voltage control section 115 may be configured with use of a DC-DC converter. A control circuit may control a switching frequency or the like to adjust the output voltage and output the first voltage or the second voltage.

### 2-7. Modification Example 7

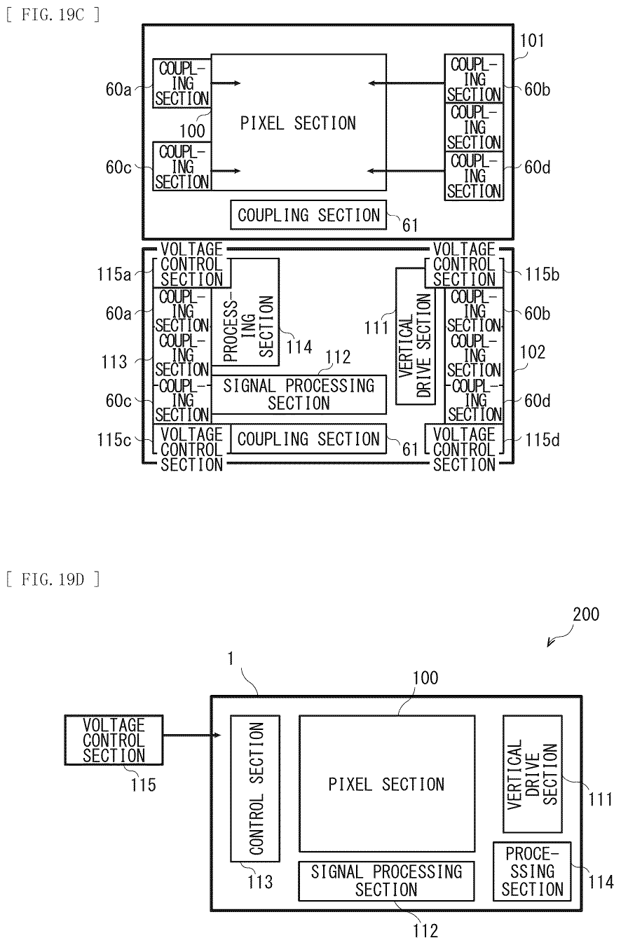

FIG. 19A to FIG. 19C are diagrams illustrating layout examples of an imaging device according to Modification Example 7. The imaging device 1 includes a first substrate 101 and a second substrate 102. The first substrate 101 and the second substrate 102 are stacked to overlap one on another. The imaging device 1 has a structure in which the first substrate 101 and the second substrate 102 are stacked. The first substrate 101 and the second substrate 102 each include a semiconductor substrate (for example, a silicon substrate). In the example illustrated in FIG. 19A, one voltage control section 115 is provided in the second substrate 102. The voltage control section 115 may be electrically coupled to the pixel section 100 of the first substrate 101 via a coupling section 60 to supply a voltage to the pixel section 100. Coupling sections 60 and 61 each include a metal electrode (for example, a metal electrode made of copper (Cu)), a through electrode, a bump, or the like.

It is to be noted that, as illustrated in FIG. 19B, two voltage control sections 115 (a voltage control section 115a and a voltage control section 115b) may be disposed on the second substrate 102. In this case, the voltage control section 115a and the voltage control section 115b may be respectively electrically coupled to the pixel section 100 of the first substrate 101 via a coupling section 60a and a coupling section 60b to supply voltages to the pixel section 100. Further, as illustrated in FIG. 19C, four voltage control sections 115 (voltage control sections 115a to 115d) and four coupling sections 60 (60a to 60d) may be disposed.

FIG. 19D is a diagram illustrating another layout example of the imaging device according to Modification Example 7. The voltage control section 115 may be provided outside of the imaging device 1. An imaging system 200 illustrated in FIG. 19 includes the imaging device 1 and the voltage control section 115. The voltage control section 115 is configured to control supply of a voltage to the imaging device 1. Even in the case of this modification example, it is possible to obtain effects similar to those of the above-described embodiment.

### 3. Application Example

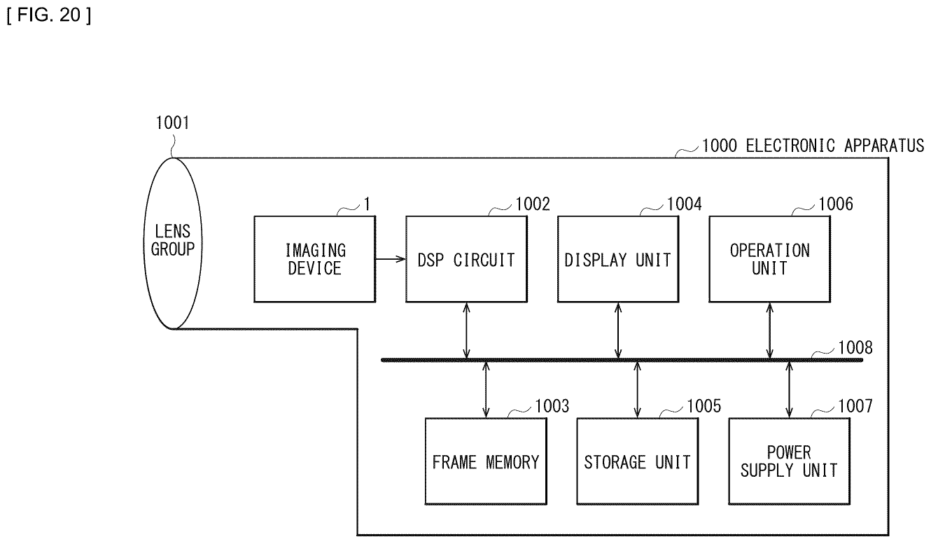

The above-described imaging device 1 or the like is applicable to any type of electronic apparatus including an imaging function such as, for example, a camera system for a digital still camera, a video camera, or the like, or a mobile phone including an imaging function. FIG. 20 illustrates a schematic configuration of an electronic apparatus 1000.

The electronic apparatus 1000 includes, for example, a lens group 1001, an imaging device 1, a DSP (Digital Signal Processor) circuit 1002, a frame memory 1003, a display unit 1004, a storage unit 1005, an operation unit 1006, and a power supply unit 1007, which are coupled to each other via a bus line 1008.

The lens group 1001 captures entering light (image light) from a subject to form an image on an imaging surface of the imaging device 1. The imaging device 1 converts the light amount of the entering light formed as an image on the imaging surface by the lens group 1001 into an electrical signal on a pixel-by-pixel basis to supply the electrical signal to the DSP circuit 1002 as the pixel signal.

The DSP circuit 1002 is a signal processing circuit that processes the signal supplied from the imaging device 1. The DSP circuit 1002 outputs image data obtained by processing the signal from the imaging device 1. The frame memory 1003 temporarily holds the image data processed by the DSP circuit 1002 on a frame-by-frame basis.

The display unit 1004 includes, for example, a panel-type display device such as a liquid crystal panel or an organic EL (Electro Luminescence) panel, and stores image data of a moving image or a still image captured by the imaging device 1 in a recording medium such as a semiconductor memory or a hard disk.

The operation unit 1006 outputs an operation signal for various functions included in the electronic apparatus 1000 in accordance with an operation performed by the user. The power supply unit 1007 is a power supply that supplies as appropriate various types of electrical power that become operation electric power for the DSP circuit 1002, the frame memory 1003, the display unit 1004, the storage unit 1005, and the operation unit 1006 to those supply targets.

### 4. Usage Examples

### Usage Example to Moving Body

It is possible to utilize the technique according to the present disclosure (present technique) for various products. For example, the technique according to the present disclosure may be implemented as a device to be mounted on a moving body of any type, such as an automobile, an electric vehicle, a hybrid electric vehicle, a motorcycle, a bicycle, a personal mobility, an airplane, a drone, a ship, or a robot.

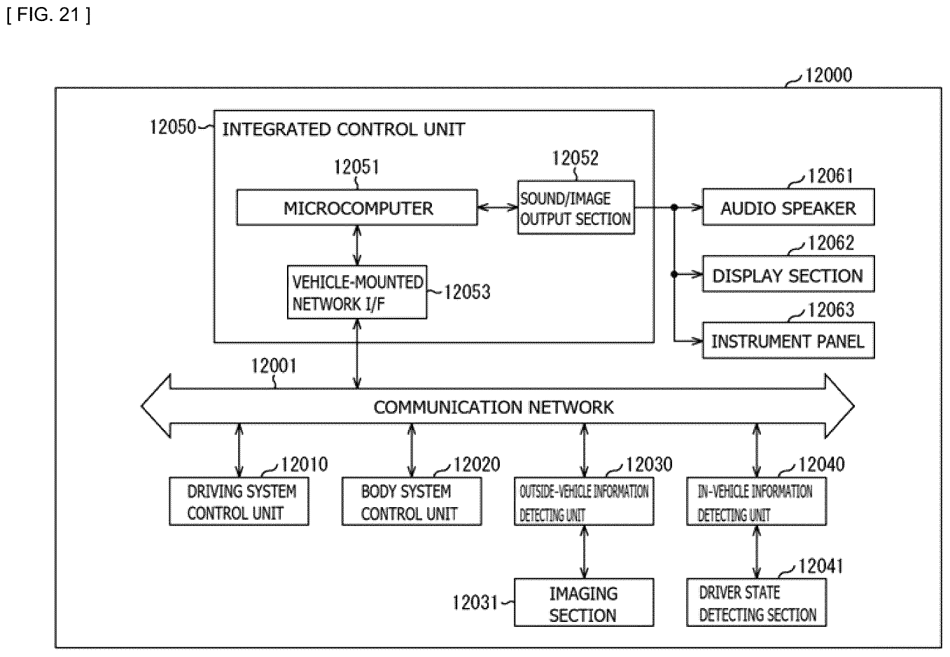

FIG. 21 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 21, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 21, an audio speaker 12061, a display section 12062, and an instrument panel 12063 are illustrated as the output device. The display section 12062 may, for example, include at least one of an on-board display and a head-up display.

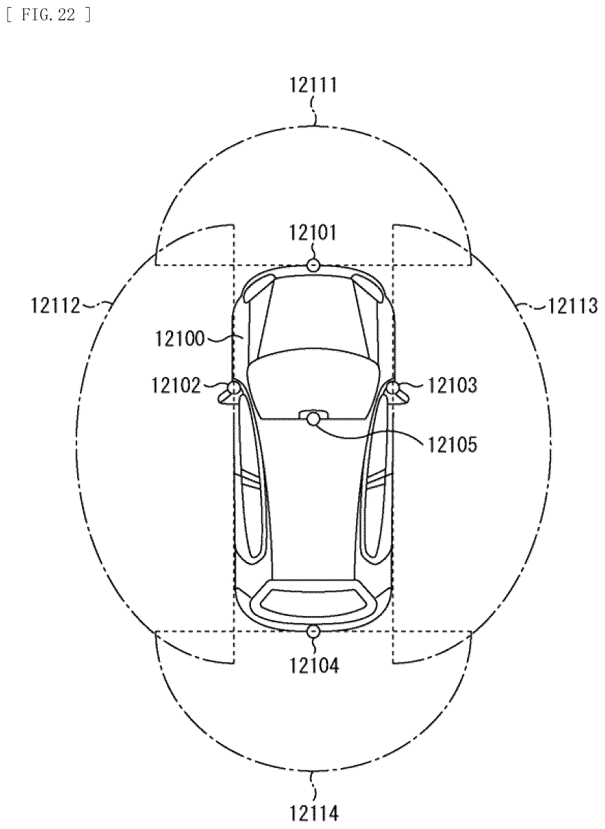

FIG. 22 is a diagram depicting an example of the installation position of the imaging section 12031.

In FIG. 22, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 22 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

Description has been given above of an example of the moving body control system to which the technique according to the present disclosure may be applied. The technique according to the present disclosure may be applied to, for example, the imaging section 12031 out of the configurations described above. Specifically, it is possible to apply, for example, the imaging device 1 and the like to the imaging section 12031. With the technique according to the present disclosure being applied to the imaging section 12031, it is possible to perform highly accurate control using a captured image in the moving body control system. For example, it is possible to implement an antitheft function that repeatedly acquires an image with low power consumption at the time of parking.

### Usage Example to Endoscopic Surgery System

It is possible to utilize the technique according to the present disclosure (present technique) for various products. For example, the technique according to the present disclosure may be applied to an endoscopic surgery system.

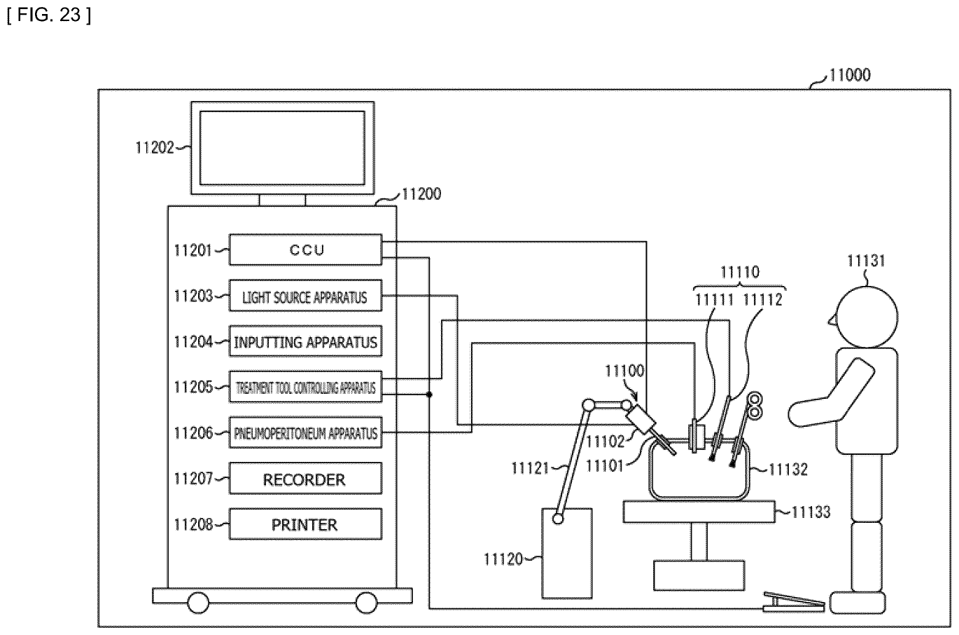

FIG. 23 is a view depicting an example of a schematic configuration of an endoscopic surgery system to which the technology according to an embodiment of the present disclosure (present technology) can be applied.

In FIG. 23, a state is illustrated in which a surgeon (medical doctor) 11131 is using an endoscopic surgery system 11000 to perform surgery for a patient 11132 on a patient bed 11133. As depicted, the endoscopic surgery system 11000 includes an endoscope 11100, other surgical tools 11110 such as a pneumoperitoneum tube 11111 and an energy device 11112, a supporting arm apparatus 11120 which supports the endoscope 11100 thereon, and a cart 11200 on which various apparatus for endoscopic surgery are mounted.

The endoscope 11100 includes a lens barrel 11101 having a region of a predetermined length from a distal end thereof to be inserted into a body cavity of the patient 11132, and a camera head 11102 connected to a proximal end of the lens barrel 11101. In the example depicted, the endoscope 11100 is depicted which includes as a rigid endoscope having the lens barrel 11101 of the hard type. However, the endoscope 11100 may otherwise be included as a flexible endoscope having the lens barrel 11101 of the flexible type.

The lens barrel 11101 has, at a distal end thereof, an opening in which an objective lens is fitted. A light source apparatus 11203 is connected to the endoscope 11100 such that light generated by the light source apparatus 11203 is introduced to a distal end of the lens barrel 11101 by a light guide extending in the inside of the lens barrel 11101 and is irradiated toward an observation target in a body cavity of the patient 11132 through the objective lens. It is to be noted that the endoscope 11100 may be a forward-viewing endoscope or may be an oblique-viewing endoscope or a side-viewing endoscope.

An optical system and an image pickup element are provided in the inside of the camera head 11102 such that reflected light (observation light) from the observation target is condensed on the image pickup element by the optical system. The observation light is photoelectrically converted by the image pickup element to generate an electric signal corresponding to the observation light, namely, an image signal corresponding to an observation image. The image signal is transmitted as RAW data to a CCU 11201.

The CCU 11201 includes a central processing unit (CPU), a graphics processing unit (GPU) or the like and integrally controls operation of the endoscope 11100 and a display apparatus 11202. Further, the CCU 11201 receives an image signal from the camera head 11102 and performs, for the image signal, various image processes for displaying an image based on the image signal such as, for example, a development process (demosaic process).

The display apparatus 11202 displays thereon an image based on an image signal, for which the image processes have been performed by the CCU 11201, under the control of the CCU 11201.

The light source apparatus 11203 includes a light source such as, for example, a light emitting diode (LED) and supplies irradiation light upon imaging of a surgical region to the endoscope 11100.

An inputting apparatus 11204 is an input interface for the endoscopic surgery system 11000. A user can perform inputting of various kinds of information or instruction inputting to the endoscopic surgery system 11000 through the inputting apparatus 11204. For example, the user would input an instruction or a like to change an image pickup condition (type of irradiation light, magnification, focal distance or the like) by the endoscope 11100.

A treatment tool controlling apparatus 11205 controls driving of the energy device 11112 for cautery or incision of a tissue, sealing of a blood vessel or the like. A pneumoperitoneum apparatus 11206 feeds gas into a body cavity of the patient 11132 through the pneumoperitoneum tube 11111 to inflate the body cavity in order to secure the field of view of the endoscope 11100 and secure the working space for the surgeon. A recorder 11207 is an apparatus capable of recording various kinds of information relating to surgery. A printer 11208 is an apparatus capable of printing various kinds of information relating to surgery in various forms such as a text, an image or a graph.

It is to be noted that the light source apparatus 11203 which supplies irradiation light when a surgical region is to be imaged to the endoscope 11100 may include a white light source which includes, for example, an LED, a laser light source or a combination of them. Where a white light source includes a combination of red, green, and blue (RGB) laser light sources, since the output intensity and the output timing can be controlled with a high degree of accuracy for each color (each wavelength), adjustment of the white balance of a picked up image can be performed by the light source apparatus 11203. Further, in this case, if laser beams from the respective RGB laser light sources are irradiated time-divisionally on an observation target and driving of the image pickup elements of the camera head 11102 are controlled in synchronism with the irradiation timings. Then images individually corresponding to the R, G and B colors can be also picked up time-divisionally. According to this method, a color image can be obtained even if color filters are not provided for the image pickup element.

Further, the light source apparatus 11203 may be controlled such that the intensity of light to be outputted is changed for each predetermined time. By controlling driving of the image pickup element of the camera head 11102 in synchronism with the timing of the change of the intensity of light to acquire images time-divisionally and synthesizing the images, an image of a high dynamic range free from underexposed blocked up shadows and overexposed highlights can be created.

Further, the light source apparatus 11203 may be configured to supply light of a predetermined wavelength band ready for special light observation. In special light observation, for example, by utilizing the wavelength dependency of absorption of light in a body tissue to irradiate light of a narrow band in comparison with irradiation light upon ordinary observation (namely, white light), narrow band observation (narrow band imaging) of imaging a predetermined tissue such as a blood vessel of a superficial portion of the mucous membrane or the like in a high contrast is performed. Alternatively, in special light observation, fluorescent observation for obtaining an image from fluorescent light generated by irradiation of excitation light may be performed. In fluorescent observation, it is possible to perform observation of fluorescent light from a body tissue by irradiating excitation light on the body tissue (autofluorescence observation) or to obtain a fluorescent light image by locally injecting a reagent such as indocyanine green (ICG) into a body tissue and irradiating excitation light corresponding to a fluorescent light wavelength of the reagent upon the body tissue. The light source apparatus 11203 can be configured to supply such narrow-band light and/or excitation light suitable for special light observation as described above.

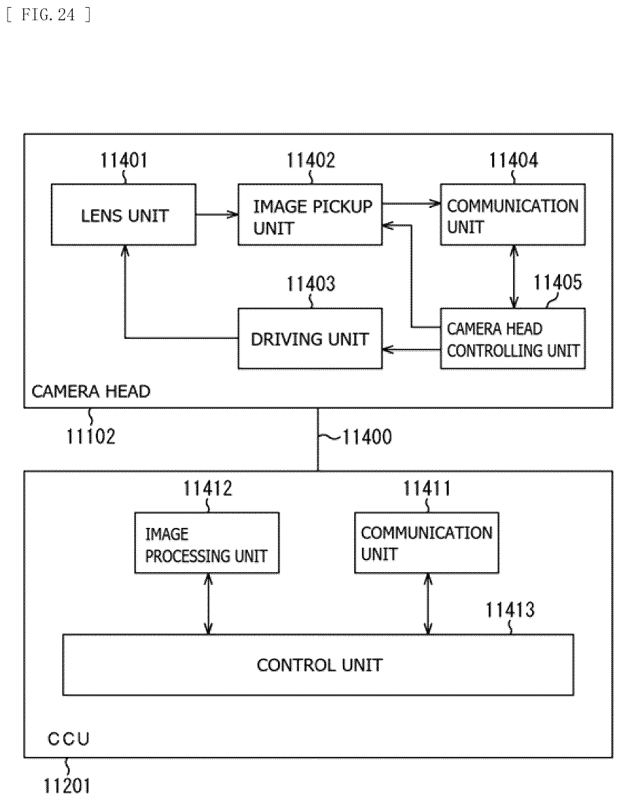

FIG. 24 is a block diagram depicting an example of a functional configuration of the camera head 11102 and the CCU 11201 depicted in FIG. 23.

The camera head 11102 includes a lens unit 11401, an image pickup unit 11402, a driving unit 11403, a communication unit 11404 and a camera head controlling unit 11405. The CCU 11201 includes a communication unit 11411, an image processing unit 11412 and a control unit 11413. The camera head 11102 and the CCU 11201 are connected for communication to each other by a transmission cable 11400.

The lens unit 11401 is an optical system, provided at a connecting location to the lens barrel 11101. Observation light taken in from a distal end of the lens barrel 11101 is guided to the camera head 11102 and introduced into the lens unit 11401. The lens unit 11401 includes a combination of a plurality of lenses including a zoom lens and a focusing lens.

The number of image pickup elements which is included by the image pickup unit 11402 may be one (single-plate type) or a plural number (multi-plate type). Where the image pickup unit 11402 is configured as that of the multi-plate type, for example, image signals corresponding to respective R, G and B are generated by the image pickup elements, and the image signals may be synthesized to obtain a color image. The image pickup unit 11402 may also be configured so as to have a pair of image pickup elements for acquiring respective image signals for the right eye and the left eye ready for three dimensional (3D) display. If 3D display is performed, then the depth of a living body tissue in a surgical region can be comprehended more accurately by the surgeon 11131. It is to be noted that, where the image pickup unit 11402 is configured as that of stereoscopic type, a plurality of systems of lens units 11401 are provided corresponding to the individual image pickup elements.

Further, the image pickup unit 11402 may not necessarily be provided on the camera head 11102. For example, the image pickup unit 11402 may be provided immediately behind the objective lens in the inside of the lens barrel 11101.

The driving unit 11403 includes an actuator and moves the zoom lens and the focusing lens of the lens unit 11401 by a predetermined distance along an optical axis under the control of the camera head controlling unit 11405. Consequently, the magnification and the focal point of a picked up image by the image pickup unit 11402 can be adjusted suitably.

The communication unit 11404 includes a communication apparatus for transmitting and receiving various kinds of information to and from the CCU 11201. The communication unit 11404 transmits an image signal acquired from the image pickup unit 11402 as RAW data to the CCU 11201 through the transmission cable 11400.

In addition, the communication unit 11404 receives a control signal for controlling driving of the camera head 11102 from the CCU 11201 and supplies the control signal to the camera head controlling unit 11405. The control signal includes information relating to image pickup conditions such as, for example, information that a frame rate of a picked up image is designated, information that an exposure value upon image picking up is designated and/or information that a magnification and a focal point of a picked up image are designated.

It is to be noted that the image pickup conditions such as the frame rate, exposure value, magnification or focal point may be designated by the user or may be set automatically by the control unit 11413 of the CCU 11201 on the basis of an acquired image signal. In the latter case, an auto exposure (AE) function, an auto focus (AF) function and an auto white balance (AWB) function are incorporated in the endoscope 11100.

The camera head controlling unit 11405 controls driving of the camera head 11102 on the basis of a control signal from the CCU 11201 received through the communication unit 11404.

The communication unit 11411 includes a communication apparatus for transmitting and receiving various kinds of information to and from the camera head 11102. The communication unit 11411 receives an image signal transmitted thereto from the camera head 11102 through the transmission cable 11400.

Further, the communication unit 11411 transmits a control signal for controlling driving of the camera head 11102 to the camera head 11102. The image signal and the control signal can be transmitted by electrical communication, optical communication or the like.

The image processing unit 11412 performs various image processes for an image signal in the form of RAW data transmitted thereto from the camera head 11102.

The control unit 11413 performs various kinds of control relating to image picking up of a surgical region or the like by the endoscope 11100 and display of a picked up image obtained by image picking up of the surgical region or the like. For example, the control unit 11413 creates a control signal for controlling driving of the camera head 11102.

Further, the control unit 11413 controls, on the basis of an image signal for which image processes have been performed by the image processing unit 11412, the display apparatus 11202 to display a picked up image in which the surgical region or the like is imaged. Thereupon, the control unit 11413 may recognize various objects in the picked up image using various image recognition technologies. For example, the control unit 11413 can recognize a surgical tool such as forceps, a particular living body region, bleeding, mist when the energy device 11112 is used and so forth by detecting the shape, color and so forth of edges of objects included in a picked up image. The control unit 11413 may cause, when it controls the display apparatus 11202 to display a picked up image, various kinds of surgery supporting information to be displayed in an overlapping manner with an image of the surgical region using a result of the recognition. Where surgery supporting information is displayed in an overlapping manner and presented to the surgeon 11131, the burden on the surgeon 11131 can be reduced and the surgeon 11131 can proceed with the surgery with certainty.

The transmission cable 11400 which connects the camera head 11102 and the CCU 11201 to each other is an electric signal cable ready for communication of an electric signal, an optical fiber ready for optical communication or a composite cable ready for both of electrical and optical communications.

Here, while, in the example depicted, communication is performed by wired communication using the transmission cable 11400, the communication between the camera head 11102 and the CCU 11201 may be performed by wireless communication.

Description has been given above of an example of the endoscopic surgery system to which the technique according to the present disclosure may be applied. The technique according to the present disclosure may be suitably applied to, for example, the image pickup unit 11402 provided on the camera head 11102 of the endoscope 11100 out of the configurations described above. With the technique according to the present disclosure being applied to the image pickup unit 11402, it is possible to provide a high-performance endoscope 11100.

The present disclosure has been described above by means of the embodiment, the modification examples, the application example, and the usage examples. However, the present technique is not limited to the above-described embodiment and others, and various modifications may be made thereto. For example, the above-described modification examples are described as modification examples of the above-described embodiment, but it is possible to combine the configurations of the respective modification examples as appropriate.

An imaging device according to one embodiment of the present disclosure includes: a photoelectric converter that photoelectrically converts light; a floating diffusion configured to store electric charge; a transfer transistor configured to electrically couple the photoelectric converter and the floating diffusion to each other; a readout circuit configured to output a first signal that is on a basis of the electric charge stored in the floating diffusion; and a voltage control section configured to control supply of a voltage to the readout circuit. The voltage control section is configured to execute control of supplying a first voltage to the readout circuit in a case where the first signal is read while the transfer transistor is in an off-state. The voltage control section is further configured to execute control of supplying a second voltage that is lower than the first voltage to the readout circuit in a case where the first signal is read while the transfer transistor is in an on-state. This makes it possible to suppress increase in power consumption. It is thus possible to achieve an imaging device that enables the power consumption to be reduced.

It is to be noted that the effects described herein are merely examples, and are not limited to their descriptions and may include other effects. Further, the present disclosure may take the following configurations.

### 1

An imaging device including:
a first photoelectric converter that photoelectrically converts light;
a first floating diffusion configured to store electric charge;
a first transfer transistor configured to electrically couple the first photoelectric converter and the first floating diffusion to each other;
a first readout circuit configured to output a first signal that is on a basis of the electric charge stored in the first floating diffusion; and
a voltage control section configured to control supply of a voltage to the first readout circuit, in which
the voltage control section is configured to:
execute control of supplying a first voltage to the first readout circuit in a case where the first signal is read while the first transfer transistor is in an off-state; and
execute control of supplying a second voltage that is lower than the first voltage to the first readout circuit in a case where the first signal is read while the first transfer transistor is in an on-state.

### 2

The imaging device according to (1), in which
the first readout circuit includes a first amplification transistor configured to output the first signal, and
the voltage control section is configured to control a voltage to be supplied to the first amplification transistor.

### 3

The imaging device according to (2), in which the first amplification transistor is configured to output, on a basis of the second voltage, the first signal that is on a basis of the electric charge resulting from conversion at the first photoelectric converter while the first transfer transistor is in the on-state.

### 4

The imaging device according to any one of (1) to (3), in which
the first readout circuit includes a first reset transistor to be electrically coupled to the first floating diffusion, and
the voltage control section is configured to control a voltage to be supplied to the first reset transistor.

### 5

The imaging device according to (4), in which the first reset transistor is configured to reset, on a basis of the second voltage, a voltage of the first floating diffusion while the first transfer transistor is in the on-state.

### 6

The imaging device according to any one of (1) to (5), further including a control section that performs control to add a capacitance to the first floating diffusion.

### 7

The imaging device according to (6), in which the voltage control section is configured to execute the control of supplying the second voltage to the first readout circuit in a case where the capacitance is added to the first floating diffusion.

### 8

The imaging device according to (6) or (7), in which the voltage control section is configured to execute the control of supplying the first voltage to the first readout circuit in a case where no capacitance is added to the first floating diffusion.

### 9

The imaging device according to any one of (1) to (8), further including:
a second photoelectric converter that photoelectrically converts light;
a second floating diffusion configured to store electric charge;
a second transfer transistor configured to electrically couple the second photoelectric converter and the second floating diffusion to each other;
a second readout circuit configured to output a second signal that is on a basis of the electric charge stored in the second floating diffusion; and
a first transistor configured to electrically couple the first floating diffusion and the second floating diffusion to each other.

### 10

The imaging device according to (9), in which the voltage control section is configured to execute the control of supplying the second voltage to the first readout circuit in a case where the first transistor electrically couples the first floating diffusion and the second floating diffusion to each other.

### 11

The imaging device according to (9) or (10), in which the voltage control section is configured to execute the control of supplying the second voltage to the first readout circuit in a case where the first transfer transistor and the second transfer transistor are each in the on-state and the first transistor electrically couples the first floating diffusion and the second floating diffusion to each other.

### 12

The imaging device according to any one of (1) to (8), further including:
a second photoelectric converter that photoelectrically converts light; and
a second transfer transistor configured to electrically couple the second photoelectric converter and the first floating diffusion to each other.

### 13

The imaging device according to (12), in which the voltage control section is configured to execute the control of supplying the second voltage to the first readout circuit in a case where the first signal is read while the first transfer transistor and the second transfer transistor are each in the on-state.

### 14

The imaging device according to any one of (1) to (13), further including:
a capacitor element configured to store electric charge; and
a second transistor configured to electrically couple the first floating diffusion and the capacitor element to each other.

### 15

The imaging device according to (14), in which the voltage control section is configured to execute the control of supplying the second voltage to the first readout circuit in a case where the second transistor electrically couples the first floating diffusion and the capacitor element to each other.

### 16

The imaging device according to any one of (1) to (15), in which the first photoelectric converter includes a photodiode buried and formed in a semiconductor substrate.

### 17

The imaging device according to (16), further including a memory section buried and formed in the semiconductor substrate, in which
the memory section is configured to hold the electric charge resulting from conversion at the first photoelectric converter.

### 18

The imaging device according to any one of (1) to (17), in which the voltage control section includes a circuit configured to select and output the first voltage or the second voltage, a resistor divider circuit, an amplifier circuit, or a DC-DC converter.

### 19

An imaging system including:
an imaging device; and
a voltage control section configured to control supply of a voltage to the imaging device, in which
the imaging device includes:
a photoelectric converter that photoelectrically converts light;
a floating diffusion configured to store electric charge;
a transfer transistor configured to electrically couple the photoelectric converter and the floating diffusion to each other; and
a readout circuit configured to output a first signal that is on a basis of the electric charge stored in the floating diffusion, and
the voltage control section is configured to:
execute control of supplying a first voltage to the readout circuit in a case where the first signal is read while the transfer transistor is in an off-state; and
execute control of supplying a second voltage that is lower than the first voltage to the readout circuit in a case where the first signal is read while the transfer transistor is in an on-state.

### 20

A method of driving an imaging device including: a photoelectric converter; a floating diffusion; a transfer transistor configured to electrically couple the photoelectric converter and the floating diffusion to each other; a readout circuit configured to output a first signal that is on a basis of electric charge stored in the floating diffusion; and a voltage control section configured to control supply of a voltage to the readout circuit, the method including:
supplying a first voltage to the readout circuit in a case where the first signal is read while the transfer transistor is in an off-state; and
supplying a second voltage that is lower than the first voltage to the readout circuit in a case where the first signal is read while the transfer transistor is in an on-state.

The present application claims the benefit of Japanese Priority Patent Application JP2022-147343 filed with the Japan Patent Office on Sep. 15, 2022, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. An imaging device comprising:
a first photoelectric converter that photoelectrically converts light;
a first floating diffusion configured to store electric charge;
a first transfer transistor configured to electrically couple the first photoelectric converter and the first floating diffusion to each other;
a first readout circuit configured to output a first signal that is on a basis of the electric charge stored in the first floating diffusion; and
a voltage control section configured to control supply of a voltage to the first readout circuit, wherein
the voltage control section is configured to:
execute control of supplying a first voltage to the first readout circuit in a case where the first signal is read while the first transfer transistor is in an off-state; and
execute control of supplying a second voltage that is lower than the first voltage to the first readout circuit in a case where the first signal is read while the first transfer transistor is in an on-state.

2. The imaging device according to claim 1, wherein
the first readout circuit includes a first amplification transistor configured to output the first signal, and
the voltage control section is configured to control a voltage to be supplied to the first amplification transistor.

3. The imaging device according to claim 2, wherein the first amplification transistor is configured to output, on a basis of the second voltage, the first signal that is on a basis of the electric charge resulting from conversion at the first photoelectric converter while the first transfer transistor is in the on-state.

4. The imaging device according to claim 1, wherein
the first readout circuit includes a first reset transistor to be electrically coupled to the first floating diffusion, and
the voltage control section is configured to control a voltage to be supplied to the first reset transistor.

5. The imaging device according to claim 4, wherein the first reset transistor is configured to reset, on a basis of the second voltage, a voltage of the first floating diffusion while the first transfer transistor is in the on-state.

6. The imaging device according to claim 1, further comprising a control section that performs control to add a capacitance to the first floating diffusion.

7. The imaging device according to claim 6, wherein the voltage control section is configured to execute the control of supplying the second voltage to the first readout circuit in a case where the capacitance is added to the first floating diffusion.

8. The imaging device according to claim 7, wherein the voltage control section is configured to execute the control of supplying the first voltage to the first readout circuit in a case where no capacitance is added to the first floating diffusion.

9. The imaging device according to claim 1, further comprising:
a second photoelectric converter that photoelectrically converts light;
a second floating diffusion configured to store electric charge;
a second transfer transistor configured to electrically couple the second photoelectric converter and the second floating diffusion to each other;
a second readout circuit configured to output a second signal that is on a basis of the electric charge stored in the second floating diffusion; and
a first transistor configured to electrically couple the first floating diffusion and the second floating diffusion to each other.

10. The imaging device according to claim 9, wherein the voltage control section is configured to execute the control of supplying the second voltage to the first readout circuit in a case where the first transistor electrically couples the first floating diffusion and the second floating diffusion to each other.

11. The imaging device according to claim 10, wherein the voltage control section is configured to execute the control of supplying the second voltage to the first readout circuit in a case where the first transfer transistor and the second transfer transistor are each in the on-state and the first transistor electrically couples the first floating diffusion and the second floating diffusion to each other.

12. The imaging device according to claim 1, further comprising:
a second photoelectric converter that photoelectrically converts light; and
a second transfer transistor configured to electrically couple the second photoelectric converter and the first floating diffusion to each other.

13. The imaging device according to claim 12, wherein the voltage control section is configured to execute the control of supplying the second voltage to the first readout circuit in a case where the first signal is read while the first transfer transistor and the second transfer transistor are each in the on-state.

14. The imaging device according to claim 1, further comprising:
a capacitor element configured to store electric charge; and
a second transistor configured to electrically couple the first floating diffusion and the capacitor element to each other.

15. The imaging device according to claim 14, wherein the voltage control section is configured to execute the control of supplying the second voltage to the first readout circuit in a case where the second transistor electrically couples the first floating diffusion and the capacitor element to each other.

16. The imaging device according to claim 1, wherein the first photoelectric converter comprises a photodiode buried and formed in a semiconductor substrate.

17. The imaging device according to claim 16, further comprising a memory section buried and formed in the semiconductor substrate, wherein
the memory section is configured to hold the electric charge resulting from conversion at the first photoelectric converter.

18. The imaging device according to claim 1, wherein the voltage control section includes a circuit configured to select and output the first voltage or the second voltage, a resistor divider circuit, an amplifier circuit, or a DC-DC converter.

19. An imaging system comprising:
an imaging device; and
a voltage control section configured to control supply of a voltage to the imaging device, wherein
the imaging device includes:
a photoelectric converter that photoelectrically converts light;
a floating diffusion configured to store electric charge;
a transfer transistor configured to electrically couple the photoelectric converter and the floating diffusion to each other; and
a readout circuit configured to output a first signal that is on a basis of the electric charge stored in the floating diffusion, and
the voltage control section is configured to:
execute control of supplying a first voltage to the readout circuit in a case where the first signal is read while the transfer transistor is in an off-state; and
execute control of supplying a second voltage that is lower than the first voltage to the readout circuit in a case where the first signal is read while the transfer transistor is in an on-state.

20. A method of driving an imaging device including: a photoelectric converter; a floating diffusion; a transfer transistor configured to electrically couple the photoelectric converter and the floating diffusion to each other; a readout circuit configured to output a first signal that is on a basis of electric charge stored in the floating diffusion; and a voltage control section configured to control supply of a voltage to the readout circuit, the method comprising:
supplying a first voltage to the readout circuit in a case where the first signal is read while the transfer transistor is in an off-state; and
supplying a second voltage that is lower than the first voltage to the readout circuit in a case where the first signal is read while the transfer transistor is in an on-state.
